(19) United States
(12) Patent Application Publication
(10) Pub. No.: US 2026/0289199 A1
(43) Pub. Date: Sep. 24, 2026

(54) SYSTEM

(71) Applicant: SoftBank Group Corp., Tokyo (JP)

(72) Inventor: Tomoyuki KAWAKAMI, Tokyo (JP)

(73) Assignee: SoftBank Group Corp., Tokyo (JP)

(21) Appl. No.: 19/567,041

(22) Filed: Mar. 14, 2026

(30) Foreign Application Priority Data
Mar. 19, 2025 (JP) 2025-045286

(51) Int. Cl. G06F 40/58; G06F 40/295

(52) U.S. Cl. CPC G06F 40/58; G06F 40/295

(57) ABSTRACT

A system includes a processor that is configured to receive information via an interface configured to receive information from a user, generate a prompt that instructs a generative AI model to generate a relevant use case in order to analyze the received information, and apply a predetermined rule to sort the information into an appropriate department or service based on the generated use case.

### CROSS-REFERENCE TO RELATED APPLICATION

This application is based on and claims priority under 35 USC 119 from Japanese Patent Application No. 2025-045286 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information processing systems that receive information from users and route the information to internal departments or services typically rely on fixed rules or simple keyword-based classification. Such systems are often unable to flexibly understand the context or intent of the user's input, particularly when the input is unstructured, lengthy, or ambiguous. As a result, user inquiries or requests may be misrouted, leading to delays, increased operational cost, and reduced user satisfaction.

Furthermore, conventional systems generally do not consider the emotional state of the user when processing and prioritizing information. In many practical scenarios, a user's emotion, such as frustration, urgency, or distress, is an important factor in deciding how quickly and in what order the information should be handled. Systems that ignore emotional cues from voice, text, or facial expressions may fail to properly prioritize urgent or sensitive cases, leading to inadequate responses or missed opportunities to improve customer experience. In addition, while generative AI models have become capable of generating rich and contextual use cases or interpretations, typical systems do not effectively integrate such models into a unified workflow for information analysis, routing, and prioritization. There is therefore a need for a system that can leverage generative AI to analyze user-provided information, automatically derive relevant use cases, route the information to appropriate departments or services according to predetermined rules, and further adjust the processing priority based on an analysis of the user's emotional state.

### SUMMARY

In order to solve the above-described problems, a system is provided that comprises a processor configured to perform an integrated series of operations for analysis, routing, and prioritization of user-provided information. The processor is configured to receive information via an interface configured to receive information from a user. The processor is further configured to generate a prompt that instructs a generative AI model to generate a relevant use case in order to analyze the received information. By using the generative AI model through the generated prompt, the system is able to derive contextual interpretations, scenarios, or use cases pertaining to the user's input, even when the input is unstructured or ambiguous.

Based on the use case generated by the generative AI model, the processor is configured to apply a predetermined rule to sort the information into an appropriate department or service. The predetermined rule may include, for example, mappings between particular categories of use cases and internal organizational units or service types. In this manner, the system can route the information to the proper destination with improved accuracy and reduced manual intervention.

In addition, in some embodiments, the processor is configured to evaluate an emotion of the user using voice data, text data, and expression data as inputs in order to analyze an emotional state of the user, and to generate an analysis result. The processor is further configured to adjust a priority of the information based on an emotion analysis result, calculate a priority score, and determine a processing order of the information based on the priority score. By combining the emotion analysis with the use-case-based routing, the system can dynamically adjust how quickly and in what order information is processed, giving higher priority to information associated with urgent or critical emotional states, and thereby improving responsiveness and user satisfaction.

The term “system” refers to an information processing apparatus, which may include one or more hardware devices such as servers, computers, or terminals, and associated software components configured to execute the processing described in the claims.

The term “processor” refers to one or more hardware processing units, such as a central processing unit (CPU), graphics processing unit (GPU), microcontroller, or other circuitry, and may include a combination of such units operating together to execute instructions for performing the claimed functions.

The term “interface” refers to a hardware and/or software component configured to receive information from a user, and may include, for example, graphical user interfaces, application programming interfaces, input devices, network interfaces, or combinations thereof.

The term “user” refers to a human operator or an entity acting on behalf of a human, who provides information to the system and may interact with the system through the interface.

The term “information” refers to data, content, or messages provided by the user, including but not limited to text, audio, image, video, or structured data, that are to be analyzed, routed, or processed by the system.

The term “prompt” refers to a structured input or instruction generated by the processor and provided to a generative AI model, the input or instruction specifying how the generative AI model should process the received information and what type of output, such as a use case, should be generated.

The term “generative AI model” refers to a machine learning model, such as a neural network-based language model or multimodal model, configured to generate output data, including but not limited to textual descriptions, scenarios, or use cases, in response to a given prompt.

The term “use case” refers to a description or scenario generated by the generative AI model that represents an interpretation, application, or contextualization of the received information, and that is used by the processor to determine how the information should be routed or processed.

The term “predetermined rule” refers to a rule or a set of rules defined in advance, which may be implemented as logical conditions, mapping tables, decision trees, or other rule representations, and which the processor applies to determine an appropriate department or service to which the information should be sorted based on the generated use case.

The term “department” refers to an organizational unit within an entity, such as a business division, support team, or functional group, that is responsible for handling certain types of information or requests.

The term “service” refers to a function or process provided by the entity or system, such as customer support, technical assistance, sales processing, or any other operational service that handles user information.

The term “voice data” refers to audio data representing speech or vocal sounds produced by the user and captured by a microphone or other audio input device.

The term “text data” refers to character-based data representing written or transcribed content provided by the user, including messages, emails, chat logs, or other textual inputs.

The term “expression data” refers to data representing facial expressions or other non-verbal cues of the user, obtained, for example, from image or video inputs and processed to infer emotional information.

The term “emotion” refers to an affective state of the user, such as anger, frustration, happiness, sadness, urgency, or calmness, as inferred by analyzing voice data, text data, and/or expression data.

The term “emotional state” refers to a condition or profile representing one or more emotions of the user at a given time, as determined by the emotion evaluation performed by the processor.

The term “analysis result” refers to data generated by the processor that represents the outcome of analyzing the user's emotional state, including, for example, an emotion label, intensity score, or other quantified representation of emotion.

The term “priority of the information” refers to a level or rank indicating the relative importance, urgency, or processing preference assigned to the information by the processor.

The term “priority score” refers to a numerical or categorical value calculated by the processor based on the emotion analysis result and optionally other factors, and used to determine the processing order of the information.

The term “processing order” refers to the sequence or schedule according to which multiple pieces of information are handled, routed, or responded to by the system, determined at least in part by the priority score.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

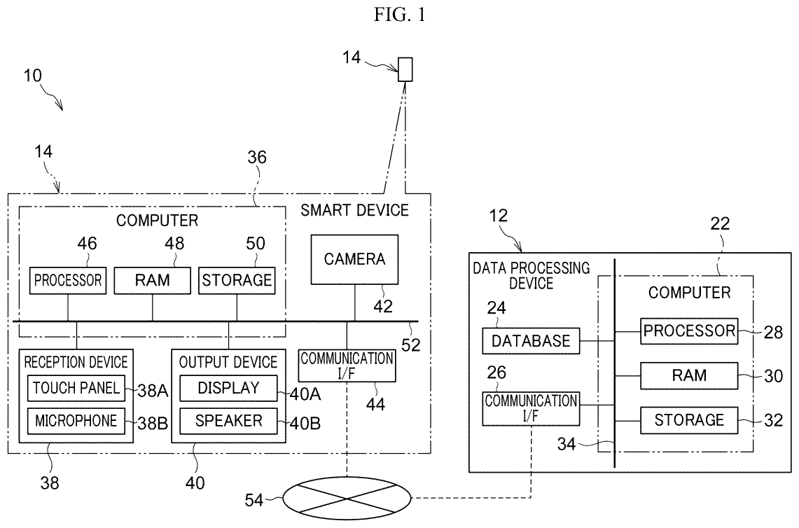

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

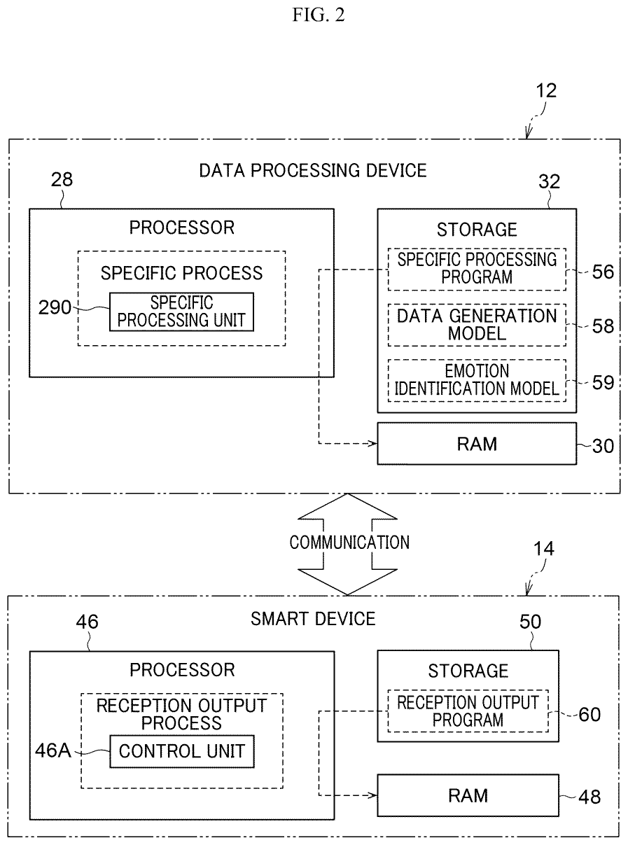

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information retrieval and business intelligence systems that target technical use cases suffer from several technical limitations when operating on large-scale, heterogeneous network data sources. First, existing web crawling and text-mining pipelines typically treat unstructured documents as flat text, without tightly integrating a generative AI model into the core extraction and ranking processes. As a result, such systems frequently fail to accurately identify, from noisy and multilingual data, those organizations that are actively utilizing specific technical domains, such as wireless communication technologies, in overseas regions. This leads to low precision and recall in entity extraction and weak discrimination between highly active organizations and those merely mentioned in passing. Second, known systems generally require a human operator to manually craft query sentences or search conditions each time the operator wants to explore new technical use cases. This manual prompt creation is cognitively demanding, highly variable in quality, and does not systematically leverage the structured analytical results already computed by the system. Consequently, even when underlying data processing is sophisticated, the interaction layer between the user and a generative AI model remains inefficient, resulting in suboptimal utilization of available computational resources and model capabilities.

Third, most existing architectures lack a unified mechanism for converting raw, unstructured network content into machine-readable structured information that is directly reusable both for (i) ranking and identifying organizations based on activity indices and (ii) automatically generating optimized prompt sentences for a generative AI model. Without such a mechanism, the system must duplicate processing steps, maintain separate data representations for search and for prompting, and handle complex glue logic in the application layer. This increases latency, resource consumption, and system complexity, and reduces robustness and scalability.

Fourth, current systems often do not provide an automated, end-to-end workflow in which: (1) document collection from public information sources, (2) language normalization, (3) semantic extraction of organizations and technical use cases by a generative AI model, (4) computation of an activity index per organization, (5) generation of structured summaries, and (6) generation of context-aware prompt sentences are executed as a coherent processing pipeline. Fragmented designs make it difficult to tune or improve the system's overall performance, to adapt to new technical domains, or to reuse prior analysis in subsequent user interactions.

Accordingly, there is a need for an improved computer-implemented system that integrates web-scale information acquisition, generative-AI-based natural language understanding, structured activity scoring of organizations, and automatic generation of question-type prompt sentences into a single architecture. Such a system should technically improve the way computers organize and represent unstructured technical information, reduce the computational and cognitive burden associated with manual query design, and enable more efficient and accurate interaction with generative AI models for exploring overseas use cases and technology-intensive organizations.

The specific processing by the specific processing unit 290 of the data processing device 12 in Example 1 is realized by the following means.

The present invention provides a server comprising a processor and a storage device, the processor being configured to execute computer programs that (i) access, via a communication network, a plurality of information providing devices and automatically collect unstructured document information from public information sources based on acquisition target identification information, (ii) extract character information from the collected document information, perform language type determination and machine translation processing to normalize the character information, and execute a natural language processing program including a generative AI model to extract, from the normalized character information, organization information and case information related to overseas use cases and utilization of wireless communication technologies, (iii) calculate, based on the extracted organization information and case information, an activity index for each organization and identify organizations having active utilization of wireless communication technologies in overseas regions, (iv) generate, based on the identified organizations and the case information, summary information in which attribute information including industry type, geographic region, technology type, and the activity index is organized, and store the summary information as structured information in the storage device, (v) execute a prompt sentence generation process that instructs the generative AI model to automatically generate a plurality of question-type prompt sentence candidates, to be used as input sentences to the generative AI model, on the basis of the summary information and the structured information, and (vi) provide the plurality of prompt sentence candidates and the summary information to an external terminal, receive from the external terminal a selected or edited prompt sentence, transmit the selected or edited prompt sentence to the generative AI model, and acquire and return response information from the generative AI model to the external terminal. This enables an integrated, computer-implemented pipeline that converts large-scale, multilingual, unstructured network content into normalized, structured, and ranked representations of organizations and technical use cases, and further into optimized, context-aware prompt sentences, thereby improving the efficiency, accuracy, and computational effectiveness of information extraction, organization ranking, and user interaction with generative AI models.

The term “processor” refers to a hardware computing unit, such as a central processing unit or graphics processing unit, that executes machine-readable instructions to perform data acquisition, data processing, and control operations in the system.

The term “storage device” refers to a non-transitory computer-readable medium, such as a semiconductor memory, magnetic storage, or optical storage, that stores programs, parameters, intermediate data, and structured information used and generated by the processor.

The term “information providing device” refers to any computing apparatus, such as a web server or application server, that provides document information via a communication network in response to access from another device.

The term “communication network” refers to a wired or wireless data communication infrastructure, such as the Internet, a local area network, or a wide area network, that enables data transmission between the server and external devices.

The term “unstructured document information” refers to information that is not stored in a predefined data model, such as natural language text, markup documents, or mixed-format content obtained from network resources.

The term “public information source” refers to an information resource, such as a web page or online repository, that is accessible over a communication network without requiring prior individualized authentication or private contractual access.

The term “acquisition target identification information” refers to data, such as uniform resource locators, keywords, or source identifiers, that specifies which public information sources or documents are to be collected by the system.

The term “character information” refers to textual content extracted from document information, including sequences of characters, words, and sentences that can be processed by natural language processing algorithms.

The term “language type determination” refers to a computational process that analyzes character information to identify the natural language in which the information is written, such as English, Japanese, or other languages.

The term “machine translation processing” refers to an automated computational process that converts character information from a source natural language into a target natural language using a translation algorithm or model.

The term “natural language processing program” refers to a software component that analyzes character information to perform tasks such as tokenization, semantic analysis, entity extraction, and text classification based on linguistic rules or learned models.

The term “generative AI model” refers to a machine learning model, such as a large language model, that generates or transforms natural language text based on input text, instructions, or contextual information.

The term “organization information” refers to data representing an entity, such as a company, institution, or group, including its name, attributes, and associated activities extracted from document information.

The term “case information” refers to data representing a specific use case, project, or deployment scenario, including context, applied technologies, and outcomes, as extracted from document information.

The term “overseas use case” refers to a case information instance that is associated with a geographic region different from a predetermined reference region defined for the system.

The term “wireless communication technology” refers to a communication technology that enables data transmission without physical wired connections, such as cellular communication, wireless local area networking, or low-power wide-area networking.

The term “activity index” refers to a numerical or categorical indicator calculated for each organization, representing a level of activity or engagement of the organization in the utilization of wireless communication technologies based on occurrence frequency and relevance information.

The term “summary information” refers to condensed data derived from organization information and case information, in which attributes such as industry type, geographic region, technology type, and activity index are organized in a compact form.

The term “attribute information” refers to descriptive data associated with organizations or cases, including but not limited to industry type, geographic region, technology type, and activity index.

The term “industry type” refers to a category that classifies an organization or case according to an economic or technical sector, such as manufacturing, logistics, or healthcare.

The term “geographic region” refers to a spatial area, such as a country, continent, or region classification, associated with an organization or case.

The term “technology type” refers to a classification label that identifies a category of technology used in a case or by an organization, such as a particular class of wireless communication technology.

The term “structured information” refers to data organized according to a predefined schema or data model, such as records, fields, and relationships, enabling efficient storage, retrieval, and processing by the system.

The term “prompt sentence generation process” refers to a sequence of computational steps in which the processor instructs the generative AI model to create natural language question-type sentences based on structured or summarized data.

The term “prompt sentence” refers to a natural language text string that is used as an input query or instruction to a generative AI model to obtain a generated response.

The term “prompt sentence candidate” refers to a prompt sentence generated automatically by the system, before selection or editing by a user, as a potential input to a generative AI model.

The term “question-type prompt sentence” refers to a prompt sentence that is expressed in an interrogative or request form, prompting the generative AI model to provide explanatory or descriptive information in response.

The term “structured information to be used as input sentences” refers to structured data that has been converted or formatted into natural language sentences suitable for submission as input to a generative AI model.

The term “external terminal” refers to an end-user computing device, such as a client computer, mobile terminal, or tablet device, that communicates with the server via the communication network.

The term “selected or edited prompt sentence” refers to a prompt sentence that has been chosen from prompt sentence candidates or has been modified by a user, and is then used as the final query to the generative AI model.

The term “response information” refers to output data generated by the generative AI model in reply to a submitted prompt sentence, including text-based answers, explanations, lists, or summaries.

The term “semantic representation” refers to a numerical or symbolic representation of the meaning of text, such as an embedding vector, that enables similarity calculations and clustering of entities or cases.

The term “similarity calculation” refers to a computational method, such as distance or similarity metric computation, that measures the degree of similarity between semantic representations.

The term “occurrence frequency information” refers to data indicating how often an entity, such as an organization or technology, appears in document information, as counted or estimated by the system.

The term “relevance information” refers to data indicating the strength of association between an entity and a particular topic or context, derived from semantic analysis of document information.

The term “inquiry condition” refers to a condition or constraint used to define the scope of a query, such as target industry, target region, target technology, or time period.

The term “time period condition” refers to an inquiry condition that specifies a temporal range, such as a set of years or dates, for which cases or activities are to be considered.

The term “business decision-making” refers to a process in which a user evaluates technical or organizational information provided by the system to support planning, strategy, or operational decisions.

In one embodiment, a server includes a processor, a main memory, a non-transitory storage device, and a network interface. The server is implemented on general-purpose hardware such as an x86-based or ARM-based server platform, and executes an operating system such as a UNIX-compatible operating system. The storage device stores executable modules for web crawling, language normalization, natural language processing, generative AI inference, activity index computation, summary generation, and prompt sentence generation, as well as data structures holding unstructured and structured information.

The server operates as a central processing node that acquires unstructured document information from public information sources, converts the unstructured information into normalized, language-unified text, performs semantic analysis using a generative AI model, calculates activity indices for organizations, generates structured summary information, and then produces question-type prompt sentences based on the structured information. The server manages internal data structures such as document tables, entity tables, relation tables, and prompt tables, and maintains indexes to accelerate retrieval and ranking.

The server, in one example, uses a web crawling framework such as a Python-based crawler to access a plurality of information providing devices via a communication network. The server stores, in a configuration file or database, acquisition target identification information including lists of target network resource identifiers, topic-specific keywords, and allowed domain patterns. The server transmits communication requests via the network interface, receives markup documents such as hypertext documents, and stores raw unstructured document information in a document repository on the storage device.

The server parses each collected document using a markup parsing module that removes markup elements unrelated to content and extracts main text segments. The server converts character encodings to a unified encoding and fragments the text into segments such as paragraphs or sentences. The server caches, for each segment, metadata including source identifier, retrieval time, detected language code, and a content hash for deduplication.

The server performs language type determination on each text segment using a statistical or neural language identification model. When a segment is not in a predetermined target language, the server applies a machine translation module that uses a neural sequence-to-sequence translation model with an encoder-decoder architecture and attention mechanisms.

The server thereby obtains normalized character information in the target language, reducing language variance before semantic analysis. This normalization reduces per-language branching in later processing and lowers memory pressure and control-flow complexity, improving computational efficiency in the subsequent generative AI model processing.

The server executes a natural language processing program that includes a generative AI model implemented as a transformer-based neural network. In one embodiment, the generative AI model is a multi-layer transformer encoder-decoder model with self-attention and cross-attention blocks, residual connections, and layer normalization units. The server loads model parameters from the storage device into main memory and, when available, offloads matrix multiplications to a graphics processing unit to accelerate inference.

The server, before inference, converts the normalized text segments into token sequences using a subword tokenization method such as byte-pair encoding or sentencepiece tokenization. The server maintains a vocabulary mapping that associates each token with an integer index. The server feeds the token sequences into the generative AI model, which applies positional embeddings and multiple attention layers to compute contextual vector representations (semantic representations) for each token and for the aggregate segment.

The server configures the generative AI model with a set of task-specific heads. For example, one head outputs entity labels for tokens (such as organization, technology, region, industry, and case descriptor), another head outputs relation scores between entities (such as organization-technology usage or organization-region association), and another head outputs classification scores indicating whether a text segment describes an overseas use case and whether a wireless communication technology is actively utilized. During development, the server trains these heads using supervised learning on annotated corpora, minimizing a composite loss function that includes token-level cross-entropy for entity labels, pairwise cross-entropy or margin-based loss for relations, and segment-level cross-entropy for classification outputs. The server updates model weights using gradient-based optimization such as stochastic gradient descent with momentum or adaptive moment estimation. The training process can incorporate data augmentation such as synonym replacement and back-translation to improve robustness across domains and regions.

In deployment, the server performs inference only, using the trained weights stored in the storage device. The server extracts, from the output of the generative AI model, entity spans, types, and confidence scores. The server aggregates these outputs across segments for each document, creating entity records that contain normalized organization names, technology identifiers, region labels, industrial sector labels, and textual descriptions of cases.

The server generates semantic representations for entities by applying an encoder layer of the generative AI model to entity-level spans and pooling the contextual vectors. The server then performs similarity calculations on these semantic representations, using distance metrics such as cosine similarity, to detect and integrate identical or highly similar organizations and cases that appear with different surface forms. This integration step reduces duplication in the entity table and yields a more compact and accurate representation of the underlying real-world entities.

The server calculates, for each organization, an activity index indicating the level of utilization of wireless communication technologies in overseas regions. The server derives multiple features for each organization, including: frequency of occurrence in segments classified as overseas use cases, weighted counts of co-occurrence with wireless communication technology terms, diversity of regions in which the organization appears, and number of distinct sources confirming the organization's activities. The server applies a scoring formula or a trained regression model that combines these features into an activity index. By using semantic outputs from the generative AI model, rather than only keyword counts, the server reduces noise due to irrelevant mentions and improves the accuracy of the activity index. This yields a technical improvement in ranking quality and reduces false positives and false negatives compared with traditional keyword-based approaches.

The server generates summary information for each organization and related cases. The server selects representative text segments associated with high-activity organizations, along with their associated attributes such as industry type, geographic region, technology type, and activity index. The server invokes the generative AI model in a summarization configuration, providing as input the selected segments with a system instruction that specifies a compact, attribute-oriented output format. The generative AI model generates concise natural-language summaries that describe the problem context, the deployed wireless communication technology, and observed effects or metrics. The server then converts these summaries into structured information by mapping extracted attributes into predefined fields of an organization-case table. The structured information is stored in a database that supports indexed queries on industry type, region, technology type, and activity index. This structured representation significantly reduces query time and computational overhead when serving downstream requests, improving data management and enabling real-time or near-real-time responses to user inquiries.

The server also executes a prompt sentence generation process that uses the structured information as an input to the generative AI model. Instead of requiring a user to manually devise queries, the server constructs a context block describing target industries, regions, technologies, and representative use cases, and instructs the generative AI model to output multiple question-type prompt sentence candidates. The server can impose constraints on the prompt sentence generation process, such as limiting length, requiring explicit mention of first-order attributes (industry, region, technology, period), and avoiding ambiguous phrasing. The generative AI model, operating under these constraints, generates prompt sentences that are optimized with respect to coverage and specificity of the structured information, thereby reducing the likelihood that subsequent calls to the generative AI model will result in irrelevant or overly broad outputs.

For example, the server can generate prompt sentences such as:

“Show me the most recent overseas use cases where 5G or Wi-Fi 6 has been used to improve factory productivity. List the organizations and summarize the results.”

“List organizations that actively use wireless communication technologies for smart logistics, and describe their main projects since 2021.”

“Generate new, plausible application ideas for wireless communication technologies in hospital operations, based on current overseas best practices.”

“Explain successful examples of wireless communication technologies deployed in smart city projects outside the domestic region, specifying the organizations and observed benefits.”

The server stores generated prompt sentences in the storage device along with metadata indicating the corresponding attribute combinations and activity index ranges used during generation. The server thereby maintains a reusable library of prompt sentence patterns that can be adapted to new data as additional documents are ingested. Because the prompt sentences are generated from structured information that is already filtered and scored, subsequent interactions with the generative AI model require fewer computation cycles for irrelevant content, reducing overall processing time and network traffic between the server and model-hosting infrastructure.

A terminal, in one embodiment, is implemented as a client computing device such as a mobile terminal, a tablet device, or a desktop client. The terminal includes a processor, memory, a display, input devices, and a communication interface. The terminal executes an application that communicates with the server via a secure communication protocol. The application retrieves structured summary information and prompt sentence candidates from the server, presents them in a user interface, and allows a user to select or edit the prompt sentences.

The terminal receives, for example, a set of prompt sentence candidates related to a specific industry, such as manufacturing or logistics, and displays them as selectable items. The terminal optionally highlights key attributes (region, technology type, time period) within each prompt to assist a user in understanding the scope of the resulting query. The terminal allows the user to modify phrases, add constraints such as “in Europe” or “after 2022,” or combine multiple conditions in a single prompt sentence. This interaction pattern reduces the cognitive load on the user and leverages the server's structured information to guide the user toward more precise and technically relevant queries.

The terminal transmits the selected or edited prompt sentence to the server or directly to a generative AI model endpoint. When the server intermediates the request, the server can attach additional structured context or system instructions derived from the stored summary information and activity indices. For example, the server may instruct the generative AI model to “prioritize organizations with higher activity index values” or to “limit explanations to cases matching the prompt constraints and confirmed by multiple independent sources.” This use of internal scoring and structured context changes the way the generative AI model's output is conditioned, improving accuracy and reducing spurious hallucinations, which is a technical improvement in model behavior driven by data structures and algorithms rather than human post-processing.

The user interacts with the terminal to view the responses generated by the generative AI model. The terminal renders lists of organizations, descriptions of overseas use cases, and suggested new application ideas. The terminal may provide features to filter, sort, or bookmark responses, but these user interface aspects are supported by the server's efficient indexing and scoring mechanisms that minimize data transfer and computation for each interaction.

From a technical standpoint, the integration of the generative AI model with structured activity indexing and prompt sentence generation provides improvements over conventional systems. The server does not merely automate a human reading and query-writing workflow; instead, the server changes how unstructured data is represented and used internally by using semantic representations and structured indices that are specifically optimized for generative prompting. The server's activity index and entity integration mechanisms reduce the dimensionality and noise of the data that the generative AI model must consider when answering queries, leading to faster inference and lower error rates. Because the generative AI model operates on pre-filtered, high-relevance contexts, hardware resources such as CPU and GPU cycles are used more efficiently, reducing energy consumption and latency per query.

Moreover, the server employs non-conventional control logic and data flows compared with standard search engines. For example, the server uses similarity-based integration of entities across multilingual sources before generating prompts, and uses the calculated activity index not only for display ranking but also as a conditioning factor in prompt design. This feedback loop between structured indexing and prompt generation constitutes a technical architecture that changes the underlying operation of the computer system, not just the content presented to a user.

The server can adopt alternative generative AI model architectures without departing from the overall concept. In another embodiment, the generative AI model is a transformer encoder-only architecture used in combination with a separate decoder component that is specifically tuned for prompt sentence generation. In yet another embodiment, the server deploys multiple models, one for entity extraction and scoring, and another for summarization and prompt generation, with a routing module that chooses which model to call based on document length, confidence thresholds, or resource availability. The server may also implement approximate nearest neighbor search for semantic vectors to accelerate entity integration, thereby reducing the computational complexity of similarity calculations on large-scale datasets.

The server can vary the training regimen of the generative AI model. In some embodiments, the server performs continual learning by periodically fine-tuning the model with new documents and new labels for organizations and technologies, using loss functions that emphasize correct identification of high-activity organizations in overseas regions. The server can also adjust model hyperparameters such as learning rate, batch size, and regularization coefficients to optimize trade-offs between accuracy and processing speed. These variations enable the system to adapt to evolving technical domains and maintain high-level performance without redesigning the entire pipeline.

The server and the terminal together form a computer system that provides technical benefits in data management, computation efficiency, and information retrieval precision. The server's conversion of heterogeneous, multilingual, unstructured documents into a unified, structured representation, followed by activity-index-driven prompt sentence generation, produces a more efficient and accurate interaction between users and generative AI models. This interaction, in turn, improves the effective bandwidth of the communication network because fewer, more targeted requests and responses are required to obtain useful information. The described embodiments thus implement concrete, technical solutions that improve computer functionality and are suitable for realization on existing hardware platforms.

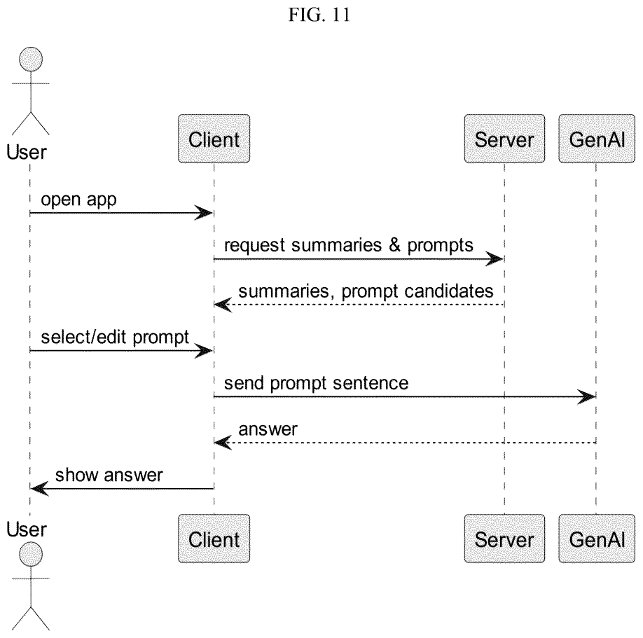

The following describes the processing flow using FIG. 11.

### Step 1:

The server collects unstructured document information from public information sources.

The server receives, as input, acquisition target identification information including a list of network resource identifiers, domain patterns, and topic keywords. Based on this input, the server sends network requests via a communication interface to multiple information providing devices, retrieves markup documents, and stores the raw document data in a document repository on a storage device. The server thereby outputs a set of raw documents, each associated with a source identifier and retrieval timestamp.

### Step 2:

The server parses and cleans the collected documents.

The server takes, as input, the raw documents stored in the document repository. The server uses a markup parser to remove non-content elements such as script tags, style tags, and navigation menus, and extracts main text segments, titles, and headings. The server converts character encodings to a unified encoding and splits the text into segments such as paragraphs or sentences. As output, the server generates normalized text segments with associated metadata including source identifier, document identifier, and segment position.

### Step 3:

The server performs language type determination and machine translation.

The server uses, as input, the normalized text segments from Step 2. For each segment, the server applies a language identification model to compute probabilities over candidate languages and determines a language label. If the label differs from a predetermined target language, the server invokes a machine translation module that processes the segment with a neural encoder-decoder model to convert it into the target language. The server outputs language-normalized text segments and updates metadata with language labels and translation flags.

### Step 4:

The server tokenizes the language-normalized text and prepares model inputs.

The server takes, as input, the language-normalized text segments with metadata. The server applies a subword tokenization method to segment each text into tokens and convert tokens into integer indices according to a vocabulary table. The server pads or truncates token sequences to a specified length and creates attention masks for the generative AI model. The server outputs batched token sequences, attention masks, and segment-level metadata for subsequent semantic analysis.

### Step 5:

The server executes a generative AI model for entity extraction and classification.

The server uses, as input, the batched token sequences and attention masks from Step 4. The server feeds these inputs into a transformer-based generative AI model, which computes contextual vector representations and applies task-specific heads for entity labeling and segment classification. The server performs data operations including matrix multiplications, attention score computations, and non-linear activations to generate output distributions over entity labels and classification categories. The server outputs, for each token and segment, predicted entity labels, confidence scores, and segment-level labels indicating whether a segment describes an overseas use case and whether a wireless communication technology is actively utilized.

### Step 6:

The server aggregates entity information across segments and documents.

The server takes, as input, the entity label outputs and confidence scores from Step 5 along with segment metadata. The server groups entities by document and by entity type, merges contiguous labeled tokens into entity spans, and filters out entities with confidence scores below a threshold. The server creates initial entity records containing raw surface forms, positions, and source references. The server outputs a collection of entity records that include candidate organization names, technology terms, region names, industrial sectors, and case descriptors.

### Step 7:

The server computes semantic representations and integrates duplicate entities.

The server uses, as input, the entity records from Step 6. For each entity span, the server applies an encoder component of the generative AI model to obtain a contextual vector representation. The server then performs similarity calculations, such as cosine similarity, between vectors to identify entities that refer to the same underlying organization or case.

The server applies clustering or threshold-based merging to combine duplicates and normalize entity names. The server outputs integrated entity records where each record represents a unique organization or case with aggregated references and normalized attributes.

### Step 8:

The server calculates an activity index for each organization.

The server receives, as input, the integrated organization records and associated case information from Step 7, including counts of appearances in overseas use cases, co-occurrences with wireless communication technologies, region diversity, and number of independent sources. The server performs data aggregation operations, such as summing weighted co-occurrences and computing normalized frequencies. The server then applies a scoring formula or regression model to map these features to a numerical activity index. The server outputs organization activity records that combine organization identifiers, computed activity indices, and feature values.

### Step 9:

The server generates summary information and structured records.

The server uses, as input, the organization activity records and associated case information from Step 8. For each organization with an activity index above a threshold, the server selects representative text segments and attributes such as industry type, geographic region, technology type, and activity index. The server may optionally invoke the generative AI model in summarization mode, providing the representative segments as input and receiving a concise textual summary as output. The server then maps each summary and attribute set into structured fields of an organization-case table. The server outputs structured summary records stored in a database, with indexes on industry, region, technology, and activity index.

### Step 10:

The server prepares context data for prompt sentence generation.

The server takes, as input, the structured summary records from Step 9. The server filters records according to predetermined criteria or query parameters, such as a specific industry or region, and composes a context block that includes key attributes, representative summaries, and lists of high-activity organizations. The server formats the context block as a compact text or structured string that can be passed to the generative AI model. The server outputs context data comprising selected summaries, attribute values, and activity indices.

### Step 11:

The server executes a prompt sentence generation process using a generative AI model.

The server uses, as input, the context data produced in Step 10. The server constructs an instruction input that specifies generation constraints, such as required inclusion of industry, region, technology, and time period in each question. The server feeds this instruction and the context block into the generative AI model configured for text generation. The server performs inference operations, including auto-regressive token generation with sampling or beam search, to produce multiple question-type prompt sentences. The server outputs a set of prompt sentence candidates, each with associated metadata indicating the context used for its generation.

### Step 12:

The server stores and indexes the generated prompt sentence candidates.

The server takes, as input, the prompt sentence candidates from Step 11 along with their associated metadata. The server writes each candidate into a prompt table in the storage device, recording fields such as text of the prompt, target industry, target region, target technology, and related activity index range. The server updates indexes to allow efficient retrieval based on these attributes. The server outputs an updated prompt repository that can be queried by the terminal according to user or system conditions.

### Step 13:

The terminal retrieves structured summaries and prompt sentence candidates from the server.

The terminal sends, as input to the server, a request including user-specified conditions such as desired industry, region, and technology focus. The server uses the request to query the structured summary records and prompt repository, and returns a response containing filtered summaries and matching prompt sentence candidates. The terminal receives this response and parses the structured data into internal data objects. The terminal outputs a display-ready list of summaries and prompt sentences.

### Step 14:

The terminal presents summaries and prompt sentence candidates to the user.

The terminal uses, as input, the parsed summaries and prompt sentences from Step 13. The terminal renders user interface elements, such as list items or cards, that show organization names, brief descriptions of overseas use cases, and associated prompt sentences. The terminal may highlight key attributes visually to help the user understand scope and relevance. The terminal outputs a graphical display through which the user can scroll, select, or edit prompt sentences.

### Step 15:

The user selects or edits a prompt sentence for querying a generative AI model.

The user views, as input, the prompt sentence candidates displayed on the terminal in Step 14. The user selects a preferred prompt by tapping or clicking on it, or opens an editing interface to modify text, add constraints (for example, “since 2022” or “in Europe”), or combine multiple attributes in one prompt. As a result, the user generates a finalized prompt sentence. The terminal receives the selected or edited text and outputs the finalized prompt sentence as a query object.

### Step 16:

The terminal transmits the finalized prompt sentence to the generative AI model.

The terminal uses, as input, the finalized prompt sentence from Step 15. The terminal constructs a request message containing the prompt sentence and optional system parameters such as response length or format. The terminal sends this message via the communication interface to a generative AI model endpoint, either on the server or on a remote computing system. The terminal outputs a network request that initiates an inference operation on the generative AI model.

### Step 17:

The server processes the prompt sentence and executes the generative AI model for answering.

When the generative AI model is hosted on the server, the server receives, as input, the finalized prompt sentence and any associated context or parameters from the terminal. The server tokenizes the prompt, applies the generative AI model in answer-generation mode, and performs auto-regressive decoding to generate a natural-language response that includes, for example, lists of organizations, explanations of overseas use cases, and proposed new applications. The server outputs generated response text, optionally with structured markers or sections.

### Step 18:

The terminal receives and displays the response from the generative AI model.

The terminal takes, as input, the response text from the server or directly from the generative AI model endpoint. The terminal parses the response, separates sections such as “Key Organizations,” “Representative Cases,” and “Proposed Applications,” and formats them for display. The terminal renders the response on the screen, allowing the user to read, scroll, and perform operations such as bookmarking or exporting. The terminal outputs a user-visible presentation of the generative AI model's response.

### Step 19:

The user evaluates the response and optionally initiates follow-up queries.

The user reads, as input, the displayed response content from Step 18. Based on this information, the user may decide to request more detail, compare additional regions or technologies, or refine conditions. The user can either manually compose a new prompt sentence or request additional prompt sentence candidates from the server through interface controls. The user's action generates new input conditions or new text queries, which are sent by the terminal to the server. The system outputs updated queries that re-enter the processing flow starting from the appropriate earlier step, enabling iterative and refined interaction.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information support systems that utilize machine learning and generative AI models typically operate as passive question-answer engines. Such systems accept a user query, forward the query more or less directly to a model, and return a textual response. These systems generally do not perform systematic collection and structuring of domain-specific external data, do not learn or refine a persistent business profile for a given user or organization, and do not adapt prompt sentences or output formats based on the user's operational context or device constraints. As a result, these systems often produce responses that are too generic, too long, or misaligned with a specific technical environment, which in turn leads to inefficient use of computational resources and degraded usefulness for users in time-critical workflows.

In addition, existing systems typically lack an integrated feedback loop in which subsequent user interactions and selection operations are used to update both user or business profiles and the prompt sentences supplied to a generative AI model. Without such continuous adaptation, the same or similar queries may repeatedly trigger redundant large-scale processing by the generative AI model, including re-analysis of already-known information, thereby consuming processing resources and network bandwidth without improving result quality.

Furthermore, when information is to be displayed on constrained visual interfaces such as wearable displays, conventional systems do not control the structure, priority, and length of generated outputs in a way that is tightly coupled to the user's state and task context. Generative AI outputs are frequently delivered as unstructured free text, which then requires additional ad hoc processing on the client side, or results in unreadable presentations on small displays. This leads to latency, cognitive overload for the user, and suboptimal utilization of computing and display resources.

Accordingly, there is a need for an improved computer-implemented system that: (i) automatically collects and normalizes external document data relevant to a technical domain, (ii) uses a generative AI model with carefully constructed prompt sentences to extract structured case information and associated attributes, (iii) maintains and updates business-type feature values and areas of interest for each user or usage entity, (iv) automatically generates new application case information tailored to those feature values and areas of interest, and (v) dynamically adapts prompt sentences and display control based on user state, device constraints, and feedback interactions. Such a system should improve the efficiency, precision, and responsiveness of the underlying computer platform itself by reducing redundant processing, structuring data in advance, and optimizing the interface between the generative AI model, the storage subsystem, and the display device.

The specific processing by the specific processing unit 290 of the data processing device 12 in Application Example 1 is realized by the following means.

The present invention provides a server comprising a processor configured to receive information from a user via an information acquisition interface; to acquire document data as public information from information resources via a communication network, perform structural analysis and removal of unnecessary elements on the document data to normalize the document data as text data, and store the normalized text data in a storage unit; to divide the text data into input segments, generate a prompt sentence that instructs a generative AI model to extract and structure case information and organization information related to communication technology from the input segments, input the prompt sentence and the input segments into the generative AI model to obtain case information, and store the obtained case information in the storage unit as structured data including attribute information; to record business type information, region information, and past inquiry history of the user or a usage entity, generate a prompt sentence for inputting the business type information, the region information, and the past inquiry history to the generative AI model, supply the prompt sentence to the generative AI model to estimate feature values and areas of interest regarding the business type information, and update the case information in the storage unit in association with the feature values and the areas of interest; to obtain the feature values and the areas of interest and the case information, generate a prompt sentence that instructs the generative AI model to generate application case information of a specific communication technology, input the prompt sentence to the generative AI model to obtain new case information, and store the obtained new case information in the storage unit in a same format as the structured data; to extract context information including a work environment of the user, a target technology, a target region, and prioritized operational indicators based on the information received from the user, generate a prompt sentence that instructs the generative AI model to select and summarize case information suitable for a request of the user based on the context information and the case information stored in the storage unit, input the prompt sentence to the generative AI model to obtain an output, and convert the obtained output into output data in a short-sentence and bullet-point format suitable for browsing on a display device; to transmit the output data to the display device, lay out the output data into a format that is successively displayable on a visual interface of the display device, and present the output data in a position superimposed within a field of view of the user during work; and to acquire subsequent inquiries and selection operations from the user via the information acquisition interface and dynamically update the prompt sentence and case selection conditions by inputting the subsequent inquiries and the selection operations again to business-type learning processing and response generation processing. This enables the computer system to reduce redundant processing by pre-structuring domain-specific information, to adapt generative AI model interactions and prompt sentences to learned business-type feature values and real-time user context, and to output prioritized, device-optimized responses that improve overall computational efficiency and usability in constrained, task-focused operating environments.

The term “information acquisition interface” refers to a hardware and/or software interface configured to receive input information from a user, including but not limited to speech input, textual input, gesture input, and selection operations, and to convert such input into machine-processable data.

The term “information resources” refers to data sources accessible via a communication network, including but not limited to web sites, databases, document repositories, and application programming interfaces that provide document data as public information.

The term “document data” refers to digital data representing human-readable content, including but not limited to web pages, articles, reports, manuals, and technical documents, typically encoded in markup or document formats.

The term “structural analysis” refers to processing applied to document data to identify and separate elements such as headings, paragraphs, main body text, sidebars, navigation components, and metadata, in order to isolate relevant textual content.

The term “removal of unnecessary elements” refers to processing for eliminating elements of document data that are not needed for subsequent analysis, including but not limited to script code, style definitions, advertisements, navigation menus, and decorative content.

The term “text data” refers to normalized, character-based data obtained from document data by structural analysis and removal of unnecessary elements, suitable for natural language processing by a generative AI model.

The term “storage unit” refers to a data storage component, implemented by one or more physical or virtual storage devices, configured to store text data, structured data, user profiles, and other information for retrieval and processing by a processor.

The term “input segments” refers to portions of text data obtained by dividing larger text data into units of a size suitable for processing by a generative AI model, for example to meet token or length constraints.

The term “prompt sentence” refers to a machine-readable instruction or instruction set, expressed in natural language or a structured format, that specifies to a generative AI model what type of processing, extraction, generation, or formatting is to be performed on given input data.

The term “generative AI model” refers to an information processing model, typically implemented by one or more machine learning models such as neural networks, configured to generate output data including natural language text, structured records, or summaries based on given input data and a prompt sentence.

The term “case information” refers to information describing an example of application of a technology or method in a real or hypothetical scenario, including attributes such as an organization, a region, a technology type, an operational context, and associated effects or benefits.

The term “organization information” refers to attribute information describing an entity involved in a case, including but not limited to an entity type, a sector, a scale, and a region, abstracted from specific proper names.

The term “structured data” refers to data stored in a format having explicit fields or attributes, such as key-value pairs, records, or tables, enabling systematic querying, filtering, and association.

The term “attribute information” refers to one or more fields associated with case information, including but not limited to technology category, application field, region, operational indicator, and relevance score.

The term “business type information” refers to information indicating characteristics of a user or usage entity, including but not limited to industry sector, operational model, service type, and typical workflows.

The term “region information” refers to information indicating a geographical or geopolitical area associated with a user, usage entity, or case, including but not limited to country, economic region, or development status.

The term “past inquiry history” refers to stored records of previous user queries, commands, and associated responses, including timestamps and contextual metadata, used to infer user preferences and patterns.

The term “feature values” refers to abstracted numerical or categorical indicators representing inferred characteristics of a business type, such as primary focus areas, frequently addressed topics, and preferred technology categories.

The term “areas of interest” refers to topics, technologies, operational themes, or regions inferred to be important to a user or usage entity, derived from business type information and past inquiry history.

The term “application case information” refers to case information that focuses on how a particular technology is or could be applied to a specific operational context, including deployment methods and expected improvements.

The term “context information” refers to information describing a current situation or environment of a user, including but not limited to a work environment, a target technology, a target region, and prioritized operational indicators, used to tailor processing by a generative AI model.

The term “work environment” refers to conditions under which a user operates, including but not limited to a location type, task type, device constraints, and interaction modalities available to the user.

The term “target technology” refers to a technology category or specific technological field that is the subject of a user request or case information, for example a particular type of communication technology.

The term “target region” refers to a geographical or geopolitical area that is the focus of a user request or case information, for example an economic region, a country group, or a development category.

The term “prioritized operational indicators” refers to one or more metrics or qualitative criteria that a user or usage entity considers particularly important for operations, such as efficiency, accuracy, latency, or safety.

The term “output data in a short-sentence and bullet-point format” refers to response data structured as concise text segments, typically including short sentences and enumerated or listed items, suitable for display within limited screen space.

The term “display device” refers to a hardware apparatus configured to present visual information to a user, including but not limited to a head-mounted display, a wearable display, or another visual interface apparatus.

The term “visual interface” refers to a user interface presented on a display device, through which textual and graphical information is visually conveyed to a user.

The term “field of view of the user” refers to a region of space visually perceived by the user when looking forward, within which visual information from a display device can be superimposed.

The term “subsequent inquiries” refers to additional queries, commands, or clarifications issued by a user after receiving an initial response, including follow-up questions and refinement requests.

The term “selection operations” refers to user actions for choosing or emphasizing particular items of information, including but not limited to selecting a case, scrolling, highlighting, or indicating preference among displayed options.

The term “feedback learning processing” refers to processing that uses subsequent inquiries and selection operations from a user to update at least one of business type information, feature values, areas of interest, prompt sentences, and case selection conditions, thereby adapting system behavior over time.

The term “classification processing” refers to processing that assigns one or more category labels to text data based on content, including but not limited to communication scheme categories, application field categories, and regional classifications.

The term “communication scheme” refers to a category of communication method or protocol, including but not limited to wireless communication methods and related technical standards.

The term “application field” refers to an area of use or industry sector in which a technology or method is applied, such as logistics operations, manufacturing processes, or information services.

The term “regional classification” refers to a categorization of regions or geographies, including but not limited to grouping by economic status, technological development level, or macro-region.

The term “state information of the user” refers to information indicating a current condition of a user relevant to information presentation, including but not limited to workload, attention level, location, or interaction mode.

The term “output length, level of detail, and presentation order” refers to parameters governing a generated response, including a maximum size or number of tokens, a degree of granularity in description, and a sequence in which items of information are presented.

The term “display priority score” refers to a value computed for each unit of output data that indicates a priority for display, determined based on user state information, relevance, and other criteria.

The term “display order and display time” refers to temporal presentation parameters specifying in which sequence output data items are shown and for how long each item remains visible on the display device.

In one embodiment, a server implements the claimed system by executing a program on a hardware platform that includes one or more multi-core processors, a main memory, nonvolatile storage, and a network interface. The server uses a general-purpose operating system, such as a Unix-like operating system, and executes application software implemented, for example, using an interpreter-type runtime environment such as a Python runtime. The server further uses a database management system, such as a relational database, and a web application framework to provide an application programming interface to at least one terminal.

Server uses a network interface to connect to a communication network such as the Internet and to obtain document data from information resources. Server uses an HTTP client library to send requests to web servers and receive HTML documents, structured documents, or files. Server performs structural analysis on each obtained document by applying a document parsing library, such as an HTML parser, to identify elements such as document headers, main article regions, navigation components, and embedded scripts. Server removes unnecessary elements, including script elements, style elements, and advertisement elements, and extracts text nodes in the main article region. Server normalizes the extracted text by converting character encodings to a unified encoding, unifying line breaks, and removing duplicated whitespace. Server stores the normalized text data in a storage unit implemented by the relational database. Each stored record includes fields such as a document identifier, a source identifier, a language code, and a timestamp.

Server divides the stored text data into input segments that meet the input constraints of a generative AI model. In one embodiment, server calculates a token count estimate based on character length and splits the text data into segments whose lengths are less than or equal to a threshold corresponding to a maximum sequence length of the generative AI model. Server maintains, for each input segment, an index structure that points back to the original document identifier, so that extracted case information can be associated with the source. Server generates a prompt sentence for each batch of input segments to instruct the generative AI model to perform specific extraction and structuring. In one example, server generates a prompt sentence such as:

“From the following text segments, extract distinct case studies related to wireless communication technologies in logistics or industrial environments. For each case, identify: (1) the type of communication technology, (2) the operational context (for example, picking, tracking, monitoring), (3) the region or market, and (4) the main operational benefits. Return the result in a consistently structured textual format.”

Server uses a generative AI model having a transformer-based neural network architecture. In one embodiment, the generative AI model is a sequence-to-sequence model composed of a plurality of transformer layers, each transformer layer including multi-head self-attention modules, feedforward sublayers, normalization layers, and residual connections. Server supplies, as input to the generative AI model, a combined sequence including the prompt sentence tokens and the tokens of the input segments. The generative AI model encodes the combined sequence by calculating attention scores between tokens, generating context-aware hidden representations, and then decoding these representations to produce an output sequence. The generative AI model has been trained in advance using a large corpus of text data by minimizing a cross-entropy loss function between predicted token distributions and ground truth tokens and by updating network weights using gradient-based optimization, such as stochastic gradient descent or an adaptive optimization method.

Server post-processes the generated output sequence by parsing the output text according to specified delimiters, field markers, or template patterns. Server uses deterministic parsing rules to identify individual case information units within the output and to extract attribute information such as technology type, operational context, region, and benefits. Server converts each identified attribute into structured data fields. The structured data is stored into the database using a table schema that includes columns for a case identifier, a technology category field, an application field, a region field, a benefits summary, and one or more relevance scores.

Server maintains business type information, region information, and past inquiry history for each user or usage entity. Server stores, for each user or usage entity, profile records that include fields such as an industry sector, a typical facility type, and priority operational indicators. Server logs past inquiry history by recording, for example, the text of each user query, a timestamp, a device identifier, and identifiers of cases returned in response.

Server uses the stored business type information and past inquiry history to estimate feature values and areas of interest. In one embodiment, server constructs an input vector representation for each user or usage entity by encoding categorical profile fields using embedding vectors and by encoding repeated topics in past inquiries using term-frequency or embedding-based representations. Server applies a dimensionality reduction or clustering method to group similar users or usage entities and to identify predominant topics. Alternatively or additionally, server calls the generative AI model with a prompt sentence that explicitly instructs the model to infer such feature values and areas of interest. For example, server generates a prompt sentence such as:

“Analyze the following list of user queries and response summaries, and infer the main business type, recurring technical topics, preferred communication technologies, and priority operational indicators. Provide a concise description of the inferred profile.”

Server converts the textual description returned by the generative AI model into structured profile fields by pattern matching and rule-based parsing. Server then updates internal profile records with the inferred feature values and areas of interest, including, for example, a primary communication technology category, a preferred region category, and a set of preferred operational indicators.

Server uses these feature values and areas of interest to generate new application case information tailored to the user or usage entity. Server constructs a composite input for the generative AI model that includes (i) the profile, (ii) a selection of previously extracted real-world cases, and (iii) a prompt sentence instructing scenario generation. In one example, server generates a prompt sentence such as:

“Given the following business profile and reference cases, generate three realistic and actionable application scenarios of wireless communication technologies that would be suitable for this business. Each scenario should state: (1) the communication technology, (2) how it is deployed in the facility, and (3) the expected improvements in the prioritized operational indicators.”

Server inputs this prompt sentence together with the profile and reference cases to the generative AI model. The generative AI model outputs scenario descriptions that server parses into structured scenario records. Server associates each scenario with the relevant profile and stores the scenarios in a dedicated table.

Server also uses context information from the current user interaction to generate prompt sentences for response generation. Server extracts, from current user input, fields such as a requested technology type, a requested region, and any explicit performance goals. Server combines this context with profile data and with stored case information, and constructs a prompt sentence that instructs the generative AI model to select and summarize relevant cases in a short, display-friendly form. In one example, server generates a prompt sentence such as:

“The user works in a logistics center and is using a wearable display with limited screen space. Based on the following profile and case summaries, answer the user's request in no more than 80 words, using 3 to 4 short bullet points. Focus on wireless communication technologies that match the requested region and operational indicators.”

Server submits this prompt sentence and the selected case summaries to the generative AI model and receives an output that server converts into a concise, bullet-point format. Server enforces, through post-processing rules, constraints on output length, phrase structure, and number of bullet points, thus ensuring that the output fits within the limitations of a wearable display and reduces cognitive load for the user.

Terminal is implemented by a wearable computing device, such as a head-mounted display or smart glasses, that includes a processing unit, a memory, a display subsystem, sensors, and a communication interface. Terminal executes a client application that maintains a secure communication channel with server. Terminal uses a microphone and a local or remote speech recognition engine to obtain user speech as text. Terminal sends recognized text to server as a user query and receives response data in a structured format.

Terminal converts the structured output data into graphical elements suitable for the display subsystem. Terminal uses a rendering engine to lay out textual bullet points and simple graphical indications within the user's field of view. Terminal may perform display scheduling based on information provided by server, such as a display priority score or a recommended display duration, to control which information is shown first and how long each item remains visible.

User operates the terminal by speaking queries, performing simple gestures, and making selection operations. User views the information superimposed on the physical environment through the display of terminal. When user performs a selection operation, such as choosing a particular case for more details or requesting alternative scenarios, terminal sends corresponding commands to server. Server interprets these commands as feedback signals and updates the inquiry history, feature values, and areas of interest.

Server uses feedback learning processing to dynamically adjust both profile estimates and prompt sentence patterns. Server monitors patterns in follow-up queries and selection operations and adjusts weights in the profile model or parameters in rule-based selection logic accordingly. For instance, server may increase a priority weight for particular technology types or operational indicators that are frequently requested or selected. Server may also modify prompt templates to place higher emphasis on such topics when instructing the generative AI model.

From a technical perspective, server improves computer performance by pre-structuring domain-specific information and optimizing the interaction between stored data, the generative AI model, and the display constraints. Because server pre-collects and normalizes document data and extracts structured case information using an off-line or batch process, server reduces the amount of raw text that must be processed in real time. During on-line user interactions, server operates primarily on structured records and profile vectors, which can be retrieved and filtered using efficient database queries. This reduces processing time, memory consumption, and network usage compared to systems that repeatedly send large raw documents to a model for each user query.

Server also improves accuracy and relevance by using learned feature values and areas of interest to filter and rank case information before the generative AI model is called for final summarization. This avoids presenting generic or irrelevant content and reduces the need for repeated trial-and-error queries by the user. Additionally, server's explicit control of prompt sentences and output formatting constraints allows the generative AI model to generate outputs that are structurally consistent, thereby simplifying parsing and display.

In one variant embodiment, server uses a dedicated classification model, such as a smaller transformer or a convolutional neural network, trained on labeled domain data, to perform classification processing on normalized text data. Server assigns category labels such as communication scheme, application field, and regional classification to each text record.

Server uses these labels as filters to select only those text segments that are relevant for case extraction. This layered approach, in which a light-weight classifier first restricts input to the larger generative AI model, reduces processing load on the generative AI model and improves overall throughput.

In another variant embodiment, server modifies internal parameters governing the construction of prompt sentences based on evaluation of past performance. Server periodically evaluates stored query-response pairs by using either statistical metrics, such as average response length and click-through rates, or by using a separate analytical model that rates clarity and relevance. Based on this evaluation, server adjusts prompt templates to specify stricter length limits, altered priority among attributes, or different explanatory styles, which leads to improved computational efficiency and better utilization of model capacity. In a further embodiment, server implements caching of intermediate representations and outputs. When similar queries are detected based on similarity metrics computed over query text embeddings, server reuses previously generated structured data or summaries instead of invoking the generative AI model again. This further reduces the number of model calls, decreases latency, and conserves computational resources.

The described embodiments are not limited to wireless communication technologies or logistics contexts. Server may apply identical structural processing, profiling, and prompt sentence control to other technical domains, such as manufacturing, healthcare, or energy systems, provided that document data, case information, and profile records are adapted accordingly. Terminal may be implemented not only as a head-mounted display but also as other constrained display devices, such as handheld terminals, in-vehicle displays, or control room panels, as long as the system benefits from concise, prioritized presentations. By tightly integrating data collection, structural normalization, structured storage, profile learning, tailored generation, and display-aware summarization, the system provides an improvement to the operation of computer systems themselves. The system reduces redundant processing, improves data management, and uses the generative AI model in a controlled, efficient manner to generate device-constrained outputs that cannot be achieved by a simple human-like manual workflow or by naive question-answering engines.

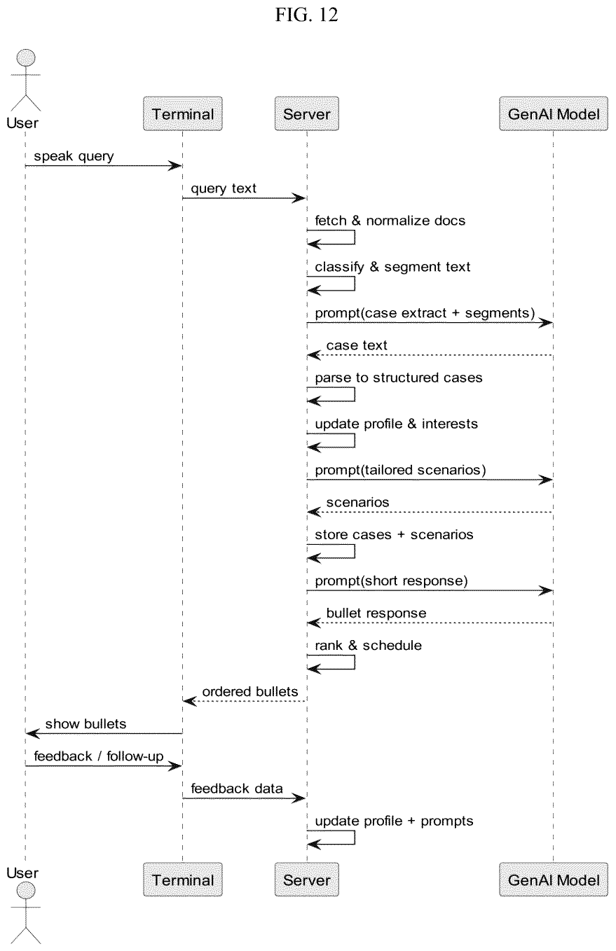

The following describes the processing flow using FIG. 12.

### Step 1:

Server acquires raw document data from information resources. Server receives, as input, a set of query parameters such as technology keywords, domain filters, and target regions, which may be preconfigured or derived from user profiles. Based on this input, server sends HTTP requests via a network interface to web servers, database APIs, or document repositories and downloads HTML pages, PDF files, or other structured documents as raw document data. Server stores this raw document data temporarily in a buffer or staging area for further processing.

### Step 2:

Server normalizes the raw document data into text data. Server takes, as input, the raw document data acquired in Step 1. Server applies parsing algorithms, such as HTML parsing and text extraction routines, to identify main content sections and to remove scripts, styles, navigation menus, and advertisements. Server converts all characters into a unified encoding and unifies line breaks and whitespace. Server outputs normalized text data, where each document is represented by a clean text string linked to metadata such as source identifier, timestamp, and language code, and stores this normalized text data in a storage unit.

### Step 3:

Server classifies the normalized text data by technical and regional categories. Server uses, as input, the normalized text data from Step 2. Server executes a classification module that applies either a trained machine learning classifier or rule-based matching on the text content to determine categories such as communication scheme, application field, and regional classification. Server calculates, for example, term frequencies or embedding vectors and compares them against predefined category profiles. Server outputs labeled text records, each associated with one or more category labels, and writes these labels back into the storage unit.

### Step 4:

Server segments the classified text data into input segments suitable for a generative AI model. Server reads, as input, the labeled text records from Step 3. Server calculates an estimated token count or character length for each text record, and splits long records into multiple segments that do not exceed a threshold associated with the generative AI model's maximum input size. Server assigns a segment identifier and a reference to the original document for each segment. Server outputs a set of input segments, each including the segment text and associated category labels, and stores them in a segment table for later use. Step 5:

Server constructs a first prompt sentence to extract case information. Server uses, as input, a batch of input segments and their category labels from Step 4. Server generates a prompt sentence that instructs the generative AI model to identify and structure case information and organization information from the segments. For example, server constructs:

“From the following text segments, extract distinct case studies related to wireless communication technologies. For each case, specify: technology type, operational context, region, and main operational benefits. Provide the results in a clearly structured textual format.”

Server concatenates this prompt sentence with the selected input segments according to a predefined template. Server outputs a combined model input sequence that will be supplied to the generative AI model.

### Step 6:

Server calls the generative AI model to extract case information. Server takes, as input, the combined model input sequence from Step 5. Server sends this input sequence to the generative AI model via an inference API, where the model uses a transformer-based neural network to compute attention scores, generate hidden representations, and decode them into an output token sequence. Server receives the output sequence, which is expected to contain multiple case descriptions formatted according to the prompt sentence. Server outputs raw generated text representing extracted case information and stores this text in a temporary area for parsing.

### Step 7:

Server parses and structures the generated case information. Server uses, as input, the raw generated text from Step 6. Server applies deterministic parsing rules, such as searching for labeled fields or markers within the text (“Technology: . . . ”, “Region: . . . ”), and uses string operations or regular expressions to separate each case and its attributes. Server maps parsed fields into a structured data schema including fields for case identifier, technology category, application field, region, benefits, and relevance score. Server outputs structured case records and inserts them into the storage unit as rows of a case information table.

### Step 8:

Server learns business type feature values and areas of interest from user profiles and inquiry history. Server takes, as input, stored user or entity profile records and past inquiry history data, including previous queries and returned case identifiers. Server converts categorical fields into numerical vectors using embeddings or one-hot encodings and aggregates query topics using term-frequency or embedding-based models. Server may further generate a prompt sentence that instructs the generative AI model to summarize the main business type and interests, such as:

“Analyze the following list of user queries and response summaries, and infer the main business type, recurring technical topics, preferred communication technologies, and priority operational indicators.”

Server supplies this prompt and associated history to the generative AI model and receives a textual summary, which server then parses into profile attributes. Server outputs updated feature values and areas of interest for each profile and stores them in a profile feature table.

### Step 9:

Server generates tailored application case information using the generative AI model. Server uses, as input, the feature values and areas of interest from Step 8 together with selected structured case records from Step 7. Server constructs a prompt sentence that instructs the generative AI model to generate new scenarios that match the profile, for example: “Given the following business profile and reference cases, generate three realistic and actionable application scenarios of wireless communication technologies suitable for this business. Each scenario should state: the communication technology, how it is deployed, and the expected improvements in the prioritized operational indicators.”

Server concatenates the profile description, reference cases, and prompt sentence into a model input sequence. Server sends this sequence to the generative AI model and obtains generated scenario descriptions. Server parses the output using pattern-based rules and converts it into structured scenario records. Server outputs these tailored application case records and stores them in an application scenario table linked to the corresponding profile.

### Step 10:

Server constructs a response prompt sentence for a real-time user query. Server receives, as input, a current user query from terminal, as well as the corresponding profile feature values and areas of interest from Step 8 and relevant case and scenario records from Steps 7 and 9. Server extracts key terms and requested constraints (such as technology type or region) from the user query. Server generates a context-aware prompt sentence, for example:

“The user is using a wearable display with limited screen space. Based on the following profile and case summaries, answer the user's request in no more than 80 words using 3 to 4 short bullet points, focusing on relevant wireless communication technologies and expected benefits.”

Server embeds selected case summaries and the user request into the prompt template. Server outputs a context-enriched model input sequence prepared for response generation.

### Step 11:

Server generates a concise response optimized for display. Server uses, as input, the model input sequence from Step 10. Server calls the generative AI model, which computes an output sequence constrained by the instructions in the prompt sentence. Server receives this output, which typically consists of multiple bullet points or short sentences. Server then applies post-processing to enforce length boundaries by counting characters or tokens, truncating overly long items, and limiting the number of bullet points. Server may also insert simple markers or formatting tokens to indicate bullet boundaries. Server outputs finalized response data in a short-sentence and bullet-point format and packages it into a structured response object.

### Step 12:

Server calculates display priority and schedules the response for the terminal. Server takes, as input, the finalized response data from Step 11 and, optionally, user state information received from terminal (such as workload or interaction mode). Server computes a display priority score for each bullet point or response item based on relevance to the query, alignment with feature values, and current user state. Server orders the response items according to the priority scores and assigns recommended display durations. Server outputs an ordered list of response items with associated timing metadata and sends this list to terminal via a network interface.

### Step 13:

Terminal presents the response data on a display device. Terminal uses, as input, the ordered list of response items and associated metadata from Step 12. Terminal converts each response item into graphical elements and arranges them in a layout suitable for the wearable display, such as stacked bullet points or paginated cards. Terminal uses the included display priority and duration to determine which item to show first and when to transition to the next item. Terminal renders the information onto the display so that the content appears superimposed within the user's field of view. Terminal outputs visual signals that guide the user through the information while minimizing occlusion of the physical environment.

### Step 14:

User provides feedback and follow-up interactions. User receives, as input, the visual information displayed by terminal from Step 13. User issues follow-up commands, such as requesting more details on a particular case or narrowing the focus to a different technology, via speech or selection actions. User's actions are captured by terminal as interaction events.

### Step 15:

Terminal transmits feedback and new queries to server. Terminal takes, as input, the interaction events from Step 14, including recognized speech text and selection identifiers. Terminal formats these events into a feedback message that includes user identifiers, selected case identifiers, and updated constraints. Terminal sends this feedback message to server via the communication network. Terminal outputs structured feedback data that server can use to refine subsequent processing.

### Step 16:

Server updates profiles and prompt patterns based on feedback. Server uses, as input, the feedback data from Step 15 and existing profile and feature values from Step 8. Server increments counters or adjusts weights associated with particular technologies, regions, or operational indicators depending on what the user selected or requested. Server may also log cases where users frequently request further detail or reject given suggestions. Using these signals, server recalculates feature values and areas of interest and updates prompt templates to emphasize or de-emphasize certain aspects in future interactions. Server outputs updated profile feature records and revised prompt parameters, which will be used in subsequent executions of Steps 8 through 12.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that support business analysis typically require users to specify query logic, filtering conditions, and ranking criteria through rigid graphical interfaces or specialized query languages. Such systems place a cognitive and operational burden on users, particularly when complex, multi-step processing is needed, including acquisition of structured financial data, data cleaning, ranking based on business metrics, and generation of analytical explanations. As a result, non-expert users are often unable to effectively leverage large-scale data resources without assistance from technical specialists.

In addition, existing systems that utilize machine learning or rule-based engines generally treat natural language inputs, database operations, and data processing pipelines as separate components that are only loosely coupled. This separation leads to inefficiencies in translating a user's natural language instructions into executable data-processing workflows. In particular, the processes of (i) interpreting an ambiguous natural language instruction, (ii) generating appropriate data acquisition conditions, (iii) performing robust preprocessing of noisy business data, and (iv) constructing a ranked list of entities based on domain-specific metrics, are not tightly integrated into a single, coherent computer-implemented pipeline. Accordingly, server resources may be underutilized or misused, and the responsiveness and reliability of the system can degrade as query complexity grows.

Further, while generative AI models can interpret natural language instructions, conventional integrations often use such models only to generate text responses, without programmatically extracting structured conditions usable for database queries and data transformations. This limits the improvement in computer functionality, because the core data processing on the server side still depends on manually defined, static mappings between language and query logic, which do not adapt well to changing user requirements or heterogeneous datasets. Moreover, known systems that incorporate emotion analysis typically use emotion detection only for content personalization at the user interface level, rather than using emotional state as a control signal to dynamically adjust server-side processing. For example, user emotion is rarely used to automatically adjust prioritization of analytical tasks, generation of additional filtering conditions, or re-ranking of business entities. As a consequence, system resources are not optimally allocated to those computations that are most relevant to the user's current state and intent, and the overall efficiency and effectiveness of the information processing apparatus remain limited.

Therefore, there is a need for a computer-implemented technique that improves the operation of a server by tightly integrating (i) natural language prompt processing using a generative AI model, (ii) automatic derivation of data acquisition and data processing conditions, (iii) robust preprocessing and ranking of structured financial or business data, and (iv) emotion-aware control of prioritization and reprocessing. Such a technique should reduce the computational overhead associated with manual configuration, improve the accuracy and relevance of the resulting ranked lists and explanations, and enhance the responsiveness and adaptability of the server in handling complex analytical requests expressed in natural language.

The specific processing by the specific processing unit 290 of the data processing device 12 in Example 2 is realized by the following means.

The present invention provides a server comprising a processor configured to receive information from a user via an information input/output device; generate a prompt sentence for instructing a generative AI model to generate a usage scenario for analyzing a natural language instruction included in the received information, input the prompt sentence into the generative AI model, and obtain, from the generative AI model, the usage scenario and data acquisition conditions and data processing conditions corresponding to the usage scenario; acquire structured data including financial information of an organizational entity by making an inquiry, on the basis of the data acquisition conditions, to a database management mechanism operating on an information processing apparatus; generate a preprocessed data set by performing preprocessing including missing-value processing, abnormal-value removal, and attribute-value conversion on the structured data using a general-purpose information processing language and a data-processing program component on the basis of the data processing conditions; generate ranked organizational-entity list data by performing sorting processing in descending order on the basis of an attribute related to sales and performing extraction processing of upper elements on the preprocessed data set to identify organizational entities having high sales; generate an additional prompt sentence for instructing the generative AI model to perform summary generation or trend analysis on the basis of the ranked organizational-entity list data and the usage scenario, and obtain explanation information from the generative AI model; convert the ranked organizational-entity list data and the explanation information into a display data format that is outputtable to the information input/output device and present the ranked organizational-entity list data and the explanation information to the user via the information input/output device; perform emotion analysis processing that evaluates an emotional state of the user using at least one of audio information, character information, and image information acquired via the information input/output device, calculate an importance index of the information received from the user on the basis of the emotional state, and control a presentation order or a presentation mode of the ranked organizational-entity list data and the explanation information in accordance with the importance index; and automatically generate an additional narrowing condition or a sorting condition for the financial information of the organizational entity on the basis of a result of the emotion analysis processing and the usage scenario obtained from the generative AI model, reprocess the preprocessed data set on the basis of the additional narrowing condition or the sorting condition to generate updated ranked organizational-entity list data, and present the updated ranked organizational-entity list data again to the user via the information input/output device. This enables an improvement of computer functionality by allowing the server to automatically translate natural language instructions into optimized database queries and data-processing workflows, to robustly preprocess and rank large-scale structured data, and to dynamically adjust prioritization and reprocessing based on user emotion, thereby enhancing processing efficiency, responsiveness, and relevance of analytical results.

The term “processor” refers to a hardware or virtual computation unit, such as a central processing unit or a processing core, that executes machine-readable instructions to perform data acquisition, data processing, model interaction, and control operations in the system.

The term “information input/output device” refers to a hardware or software interface, such as a display, keyboard, pointing device, microphone, camera, or network-based user interface, that enables a user to input information to the system and to receive information output from the system.

The term “user” refers to a human operator or an external agent that provides information or instructions to the system and receives processing results from the system via the information input/output device.

The term “prompt sentence” refers to a sequence of characters or tokens representing a natural-language or machine-readable instruction that is supplied to a generative AI model to request generation of a usage scenario, conditions, summaries, or other model outputs.

The term “generative AI model” refers to a software-based artificial intelligence model, implemented for example by a neural network, that generates output data such as text, structured conditions, or summaries in response to an input prompt sentence.

The term “usage scenario” refers to a representation of a use case or analytical context inferred by the generative AI model from a prompt sentence, the representation including information such as a target domain, target entities, and intended analytical objectives.

The term “data acquisition conditions” refers to structured parameters, such as attribute constraints, selection criteria, and temporal ranges, that specify how and which data are to be retrieved from a data store or database management mechanism.

The term “data processing conditions” refers to structured parameters, such as preprocessing steps, transformation rules, filtering criteria, and ranking metrics, that specify how acquired data are to be cleaned, converted, analyzed, or otherwise processed by the system.

The term “database management mechanism” refers to a hardware and software combination, such as a database server and its management modules, that stores, organizes, retrieves, and manages structured data in response to queries issued by the processor.

The term “information processing apparatus” refers to an electronic computing environment, including one or more processors, memory devices, storage devices, and communication interfaces, that executes software components such as the database management mechanism and data-processing programs.

The term “structured data” refers to data organized in a predefined schema, such as tables, fields, and records, in which individual attributes, including financial information, are represented in machine-parsable formats.

The term “financial information” refers to numerical or categorical data that describe an economic state of an organizational entity, including at least sales, revenue, profit, assets, liabilities, or other financial attributes.

The term “organizational entity” refers to a business unit, enterprise, corporation, institution, or similar organization for which financial information or other business attributes can be defined and processed.

The term “general-purpose information processing language” refers to a programming language capable of describing data-processing logic, such as loading data, performing computations, and implementing algorithms, without being specialized to a particular application domain.

The term “data-processing program component” refers to a software module or library function that performs operations on data, including at least loading, filtering, aggregating, transforming, or analyzing data sets according to specified conditions.

The term “preprocessed data set” refers to a collection of data records obtained from structured data after the application of preprocessing operations such as missing-value processing, abnormal-value removal, and attribute-value conversion, the collection being ready for subsequent analysis or ranking.

The term “missing-value processing” refers to an operation that handles absent or undefined attribute values in data records, the operation including, for example, filling values according to a rule, estimating values, or excluding incomplete records.

The term “abnormal-value removal” refers to an operation that detects and eliminates data records or attribute values that deviate from expected ranges or patterns, such as outliers or inconsistent values, according to predetermined criteria.

The term “attribute-value conversion” refers to an operation that changes a representation or type of an attribute value, such as converting text to numeric form, normalizing scales, aggregating categories, or mapping values to derived attributes.

The term “attribute related to sales” refers to a data field or combination of fields in the structured data that quantitatively or qualitatively represents sales activity of an organizational entity, including revenue, turnover, or similar sales indicators.

The term “ranked organizational-entity list data” refers to data representing multiple organizational entities arranged in an order determined by one or more ranking criteria, such as sales-related attributes, and including information sufficient to identify each organizational entity and its rank.

The term “upper elements” refers to one or more entries in a ranked set of organizational entities that occupy top positions according to a ranking criterion, for example the first N entities having the highest values of an attribute related to sales.

The term “summary generation” refers to a process in which the generative AI model produces condensed textual or structured output that describes key aspects, patterns, or findings derived from input data such as the ranked organizational-entity list data.

The term “trend analysis” refers to a process in which the generative AI model or the processor identifies and describes changes, patterns, or relationships over time or across attributes in input data, and outputs a representation of such changes or patterns.

The term “explanation information” refers to output data, typically in natural-language form, generated by the generative AI model that explains, interprets, or contextualizes analytical results, including at least summaries, trend descriptions, or reasoning related to the ranked organizational-entity list data.

The term “display data format” refers to a data representation, such as a markup structure, graphical layout specification, or serialized object, that is suitable for being rendered or presented by the information input/output device.

The term “emotion analysis processing” refers to a computational procedure that receives as input at least one of audio information, character information, and image information associated with a user, and generates as output an estimate of an emotional state of the user.

The term “audio information” refers to sound data captured or received by the system, including at least spoken utterances of a user, which can be processed for features such as tone, pitch, and prosody.

The term “character information” refers to textual data, including user-entered text or transcriptions of speech, that can be analyzed to infer sentiment, intent, or other linguistic indicators of emotion.

The term “image information” refers to visual data, including still images or video frames, that may contain facial expressions, gestures, or other visual cues used to estimate a user's emotional state.

The term “emotional state” refers to an inferred condition of a user, such as stress level, satisfaction, urgency, or other affective attributes, estimated by the emotion analysis processing from one or more modalities.

The term “importance index” refers to a computed indicator value that represents a relative importance or priority level assigned to information or requests from the user, the value being determined based at least on the emotional state.

The term “presentation order” refers to a sequence in which elements of information, such as organizational entities in a ranked list, are displayed or output to the user.

The term “presentation mode” refers to a manner or style in which information is visually or otherwise output to the user, including emphasis, level of detail, layout, timing, or interaction patterns.

The term “additional narrowing condition” refers to a further constraint, such as a filter or selection rule, applied to a data set to reduce the number of records or focus on a subset of organizational entities that meet specific criteria.

The term “sorting condition” refers to a rule or specification that defines an order for arranging elements in a data set, including at least a selected attribute and a direction of ordering.

The term “updated ranked organizational-entity list data” refers to a revised ranked list of organizational entities generated by applying at least one additional narrowing condition or sorting condition to the preprocessed data set and re-ranking the resulting records.

In one embodiment, a server implements the claimed system as a network-connected computing apparatus including at least one processor, a main memory, a non-volatile storage device, and a network interface. The server executes an operating system, a database management mechanism, a runtime environment for a general-purpose information processing language, and a generative AI model execution environment. The server communicates with one or more terminals operated by users. Each terminal includes an information input/output device, such as a display, a pointing device, a keyboard, a microphone, and a camera, and executes a client application or web browser that exchanges messages with the server over a communication network.

The user operates the terminal to provide natural language instructions to the server. The terminal captures user input as character information, audio information, and image information. For example, the terminal displays a text input field and a “send” button on a graphical user interface. The user enters a prompt sentence such as “Collect the financial data of IT industry companies and show the top 10 by revenue” or “Show the top 20 companies by revenue in the information technology sector in a specific country.” The terminal converts the entered text into a structured message including metadata such as a session identifier, a user identifier, and a timestamp, and transmits the message to the server via a secure communication protocol.

The server receives the message from the terminal through the network interface and stores the message data in the main memory. The server parses the message and extracts at least a prompt sentence representing a natural language instruction. The server then generates a model input structure for a generative AI model. The server includes, in this structure, the prompt sentence, context information about available data attributes (for example, attributes related to industry, country, sales amount, profit, assets, liabilities, and fiscal year), and configuration parameters indicating that the model should output a usage scenario, data acquisition conditions, and data processing conditions in a machine-interpretable format.

The server executes the generative AI model on the processor. In one embodiment, the generative AI model is implemented as a transformer-based neural network that includes an embedding layer, multiple attention layers, feedforward layers, and an output projection layer. The server stores model parameters, including weight matrices and bias vectors, in the storage device and loads relevant portions into main memory for inference. The server converts tokens of the prompt sentence into embedding vectors and applies multi-head self-attention operations to produce contextual representations. The server then decodes these representations into an output sequence that encodes a usage scenario and associated conditions.

The server defines a constrained output format for the generative AI model. For example, the server instructs the model to output explicit tags or key-value-style elements that represent: a target industry, a target region, a time period, a primary ranking metric (such as sales-related attributes), and preprocessing operations. By constraining the output, the server ensures that the generative AI model produces structured conditions rather than only free-form text. This structure allows the server to reliably map model outputs to concrete database queries and data-processing steps. This reduces parsing errors and improves consistency of the system's behavior, which in turn improves processing accuracy and efficiency relative to manual or ad-hoc condition specification.

The server stores the usage scenario and the data acquisition conditions and data processing conditions in memory as internal data structures, such as objects including fields for industry, country, fiscal year, minimum revenue thresholds, missing-value handling policies, abnormal-value thresholds, and sorting keys. The server then controls the database management mechanism to acquire relevant structured data. In one embodiment, the database management mechanism is a relational database system running on the same information processing apparatus as the server or on a separate machine. The server generates a query structure that selects specific columns (for example, organizational-entity identifier, entity name, industry, region, revenue, profit, assets, liabilities, and fiscal year) from one or more tables storing financial information.

The server applies the data acquisition conditions from the generative AI model to the query structure. For example, when the usage scenario specifies that the user is interested in entities in the information technology sector during a specific fiscal year, the server includes conditions corresponding to an industry attribute and a fiscal year attribute. When the usage scenario further specifies a particular region or a minimum sales volume, the server adds corresponding predicate conditions. The server transmits this query structure to the database management mechanism. The database management mechanism retrieves rows meeting these conditions and returns them to the server in a tabular format.

The server receives the tabular data and constructs an internal structured data representation in memory. The server then performs preprocessing based on the data processing conditions. In one embodiment, the server uses a general-purpose information processing language runtime to execute data-processing program components. The server invokes program components for missing-value processing, abnormal-value removal, and attribute-value conversion. For missing-value processing, the server may apply different rules per attribute type, such as using median values within the same industry for missing profit values, or excluding records with missing essential identifiers. For abnormal-value removal, the server may compute distribution statistics, such as mean and variance of a sales-related attribute, and exclude values exceeding a multiple of the standard deviation. For attribute-value conversion, the server may convert string representations of numeric amounts into numerical data types, normalize currencies to a common reference, or compute derived attributes such as profit margin from existing attributes.

The server applies these preprocessing operations in a predefined sequence stored as a processing pipeline. By defining the pipeline as a sequence of modular program components, the server can reuse internal buffers, minimize repeated scanning of the data, and reduce memory allocations. This structured pipeline improves computational efficiency and reduces processing time compared to ad-hoc or manual data manipulation. The result of the preprocessing pipeline is a preprocessed data set stored in memory as a collection of records each containing consistent, validated values for sales-related attributes and other attributes used in ranking.

The server then generates ranked organizational-entity list data. The server selects an attribute related to sales as a primary sorting key, such as an annual sales amount or equivalent metric. The server orders the records in the preprocessed data set in descending order according to this attribute. The server may use an in-memory sorting algorithm optimized for partially ordered data and for typical data sizes expected in financial datasets.

The server then extracts “upper elements” from the sorted data, such as the top N entities, where N is determined from the usage scenario or a default system parameter. The server adds a rank value field to each selected entity record, representing the entity's position in the order. The resulting ranked organizational-entity list data is stored as a structured list that can be transferred or further processed.

The server uses the generative AI model again to generate explanation information. The server constructs another prompt sentence that includes a textual description of the ranking objective and a representation of key fields from the ranked organizational-entity list data. For example, the server constructs a prompt sentence such as “Given the following ranking of IT companies by revenue, summarize notable trends and differences among the top entities.”

The server feeds this prompt sentence and a compact representation of the ranked data into the generative AI model. The generative AI model, which uses the same transformer architecture, generates explanation information in natural language that describes patterns, such as concentration of revenue among top entities, dominance of specific regions, or correlation between revenue and profit margin. The server stores this explanation information and associates it with the ranking data.

The terminal receives the ranked organizational-entity list data and the explanation information from the server. The terminal formats the ranked list into a visual table, showing attributes such as rank, entity name, industry, region, and sales-related value, and displays the explanation information near the table. The user can visually inspect the ranking, scroll through the list, and, if necessary, issue further prompt sentences such as “Filter to entities with profit margin above 10%” or “Show only entities in a particular country.” The terminal transmits these prompt sentences to the server, which performs the above-described operations again with updated usage scenarios and conditions.

The server also implements emotion analysis processing based on information received from the terminal. The terminal captures additional user data, such as spoken utterances via the microphone or facial images via the camera. The terminal transmits audio information and image information, possibly in encoded form, along with character information representing user-entered text, to the server. The server stores this information in memory and applies emotion analysis models. In one embodiment, the server executes a speech emotion recognition algorithm on audio features such as pitch, energy, and spectral properties, a text sentiment analysis algorithm on character information, and a facial expression recognition algorithm on image information. These algorithms may be implemented by separate neural networks or statistical models, each trained on labeled data.

The server fuses outputs of the different emotion analysis models to estimate an emotional state of the user, such as a stress level or urgency level. The server converts the emotional state into an importance index, a numerical value indicating a priority level assigned to the current user instruction. The server stores this importance index and uses it to decide the order in which to process multiple simultaneous requests, or the order and style in which to present analytical results. For example, when the importance index is high, the server may allocate more computation resources to the corresponding request, preempt lower-priority tasks, and generate more detailed explanation information. The server may also instruct the terminal to highlight particular parts of the ranking, such as the top entities, with visual emphasis.

The server further uses the emotional state and the usage scenario to generate additional narrowing conditions or sorting conditions. For instance, when emotion analysis indicates confusion or dissatisfaction, and the usage scenario indicates that the user is focusing on a specific region or industry, the server may automatically derive additional constraints to simplify the display, such as limiting the ranking to a smaller subset of entities or changing the sorting condition to a more relevant secondary attribute (for example, profit margin instead of absolute sales). The server then reprocesses the preprocessed data set using these automatically generated conditions, producing updated ranked organizational-entity list data that is more aligned with the inferred needs of the user.

By combining structured outputs from a generative AI model with emotion-aware control and modular data-processing pipelines, the server improves computer functionality in several ways. First, the server reduces the need for complex manual configuration of queries and transformations by converting natural language prompt sentences into structured conditions that are directly consumable by data-processing components. This reduces parsing overhead and error rates. Second, the server controls the data-processing pipeline and resource allocation dynamically based on the importance index and emotional state, which improves utilization of processor and memory resources and reduces latency for high-priority analyses. Third, the server implements specific algorithms for missing-value processing, abnormal-value removal, and attribute-value conversion, which increase data quality and reduce error propagation in downstream ranking and explanation generation.

In another embodiment, the server deploys the generative AI model and emotion analysis models on separate accelerator hardware, such as graphics processing units or dedicated neural processing units. The server schedules inference tasks so that generative AI model operations and emotion analysis operations are executed in parallel with database operations and data-processing tasks. This concurrency reduces the total processing time for complex requests that require both condition generation and explanation generation. The server manages intermediate data in an in-memory data structure that minimizes copying between components, thus reducing communication overhead between modules.

In a further embodiment, the server supports multiple databases storing different types of organizational-entity information, such as sector-specific transaction logs or regional economic indicators. The server extends the usage scenario to include selection of appropriate data sources. The generative AI model is trained or configured to output not only attribute-level conditions but also database-selection indicators. The server uses these indicators to direct queries to the appropriate data sources, thereby improving retrieval accuracy and reducing unnecessary data transfer. This selective retrieval further contributes to improved computational efficiency and reduced network traffic.

The user benefits from the described system because the user can express complex analytical tasks using prompt sentences such as “Collect the financial data of IT industry companies and show the top 10 by revenue,” “Filter to entities with profit margin above 10%,” or “Show the top 20 IT companies by revenue in a particular region in the last fiscal year.” The server, by virtue of its integration of a generative AI model, database management mechanism, emotion-aware prioritization, and structured data-processing pipeline, converts these natural language instructions into optimized, machine-executable processing flows. The resulting system behavior goes beyond simple automation of human analytical steps and constitutes a technical improvement in how the server manages data, allocates resources, and reduces processing errors and latency.

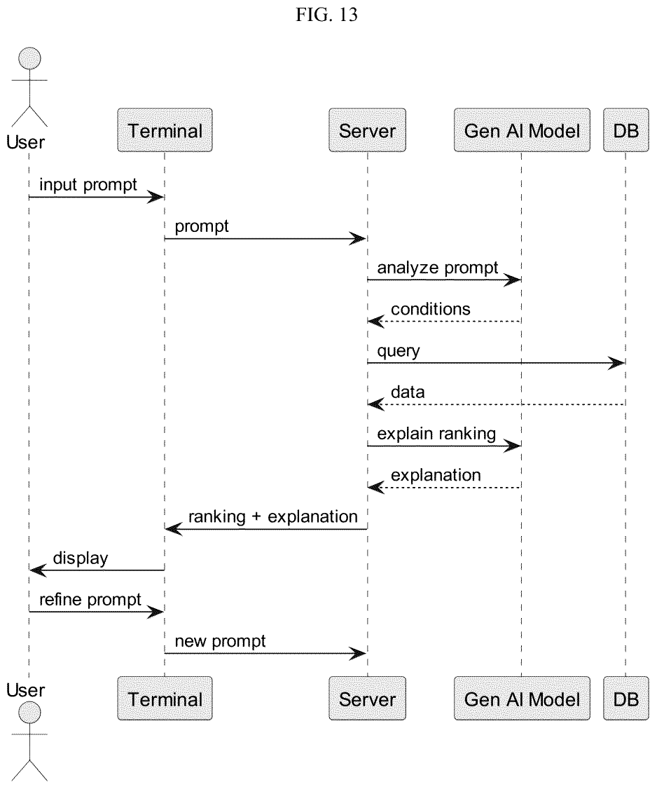

The following describes the processing flow using FIG. 13.

### Step 1:

The user provides an initial instruction.

The user operates the terminal and inputs a prompt sentence, for example, “Collect the financial data of IT industry companies and show the top 10 by revenue.” The terminal receives this text as input together with context such as a user identifier, a session identifier, and a timestamp. The terminal packages these items into a request message and transmits the message to the server over a network. The output of this step is a structured request containing at least the prompt sentence and metadata, delivered to the server.

### Step 2:

The server parses the received request.

The server receives, as input, the structured request from the terminal. The server extracts the prompt sentence, the user identifier, and the session identifier, and stores them in main memory as separate fields. The server checks the integrity of the message (for example, verifying that the prompt sentence is non-empty) and logs the request for auditing. The server outputs an internal representation of the user request that is ready to be passed to the generative AI model.

### Step 3:

The server generates and sends a model input for the generative AI model.

The server takes as input the internal representation of the user request including the prompt sentence. The server constructs a model input structure that includes: (i) the prompt sentence itself, (ii) a description of available data attributes such as industry, country, revenue, profit, assets, liabilities, and fiscal year, and (iii) configuration parameters indicating that the generative AI model should output a usage scenario and explicit data acquisition conditions and data processing conditions. The server formats these elements into a sequence of tokens accepted by the generative AI model and sends this sequence to the model execution environment. The output of this step is a model-ready input sequence stored in memory and supplied to the generative AI model.

### Step 4:

The server executes the generative AI model to derive structured conditions.

The server receives, as input, the tokenized model-ready sequence. The generative AI model, implemented for example as a transformer-based neural network, processes the input sequence by performing embedding, multi-head attention, and feedforward computations using stored weight parameters. Based on these computations, the generative AI model outputs a sequence that encodes a usage scenario and associated conditions in a constrained, tag-like format. The server decodes this output sequence into structured data: for example, a target industry (IT), a time period (latest fiscal year), a primary ranking metric (revenue), a limit (top 10), and preprocessing rules (missing-value filling strategy and abnormal-value thresholds). The output of this step is a set of structured usage scenario objects, data acquisition conditions, and data processing conditions stored in the server's memory.

### Step 5:

The server generates a database query from the data acquisition conditions.

The server takes, as input, the data acquisition conditions produced by the generative AI model. The server maps these conditions to elements of a database schema maintained by a database management mechanism. The server constructs a query specification that includes a selection of columns (such as entity identifier, entity name, industry, region, revenue, profit, assets, liabilities, and fiscal year), a table or view name, and filter predicates corresponding to the target industry, the time period, and any additional constraints. The server also specifies sorting or grouping clauses if required at the database level. The output of this step is a fully defined query specification ready to be executed by the database management mechanism.

### Step 6:

The server acquires structured data from the database management mechanism.

The server provides, as input, the query specification to the database management mechanism running on an information processing apparatus. The database management mechanism parses the query, selects relevant data blocks from storage, and returns rows that satisfy the specified conditions. The server receives a tabular result set, which may contain many records and fields. The server converts this result set into an internal structured data representation, such as an array of records with named attributes. The output of this step is structured data including financial information of organizational entities that meet the acquisition conditions.

### Step 7:

The server prepares data for preprocessing.

The server takes, as input, the structured data obtained from the database management mechanism. The server validates that required attributes (such as entity name and revenue) are present and that their data types match expected formats. The server organizes the data in memory as a uniform collection, ensuring consistent field ordering and indexing. The server may also compute initial statistics, such as counts and basic distribution measures for key attributes, to guide subsequent preprocessing. The output of this step is a normalized structured dataset that is ready for application of data processing conditions.

### Step 8:

The server performs missing-value processing and abnormal-value removal.

The server takes, as input, the normalized structured dataset and the data processing conditions obtained from the generative AI model. The server applies a missing-value policy to attributes flagged as critical or optional. For example, the server may remove records with missing entity names and may fill missing profit values using median profit within the same industry. The server then analyzes distribution statistics for sales-related attributes, compares each value to a threshold defined by the data processing conditions (for example, multiples of a standard deviation), and marks or removes records whose values are considered abnormal. Through these operations, the server performs data transformations that change individual attribute values, add imputed values, and discard outlier records. The output of this step is a cleaned dataset in which missing and abnormal values have been treated according to explicit rules.

### Step 9:

The server performs attribute-value conversion and feature normalization.

The server takes, as input, the cleaned dataset from the previous step. The server examines attribute types and conversion rules specified in the data processing conditions. For numeric fields represented as text, the server converts them into numeric formats. For monetary values in different currencies, the server may convert them into a common base currency using stored exchange-rate tables. The server may also compute derived attributes, such as profit margin from revenue and profit, and normalize certain attributes by scaling them to a predefined range. These conversions and derivations alter the internal representation of the data, making it suitable for consistent comparison and ranking. The output of this step is a preprocessed data set that contains fully typed, normalized, and derived attributes.

### Step 10:

The server identifies high-sales entities by ranking.

The server receives, as input, the preprocessed data set and the specified ranking metric, such as a sales-related attribute. The server orders the records in descending order according to the selected attribute. The server then extracts a specified number of top records, such as the top 10 or top 20 entities, based on the limit in the data processing conditions. The server assigns a rank value to each selected record by its position in the ordered sequence. This ranking operation transforms the preprocessed data set into a logically ordered list emphasizing entities with high sales values. The output of this step is ranked organizational-entity list data consisting of top-ranked entities and associated attributes.

### Step 11:

The server prepares data and a prompt sentence for explanation generation.

The server takes, as input, the ranked organizational-entity list data and the previously determined usage scenario. The server extracts representative fields, such as entity names, industries, regions, and sales values, from each top-ranked record and compresses this information into a summary representation. Based on the usage scenario and the type of ranking, the server constructs a new prompt sentence, for example, “Given the ranking of IT sector entities by revenue, describe notable trends and key differences among the top entities.” The server combines this prompt sentence with the summary representation as a model input structure. The output of this step is a second model-ready input for the generative AI model.

The server uses the generative AI model to generate explanation information.

The server provides, as input, the second model-ready structure to the generative AI model. The generative AI model processes the prompt sentence and the summary representation through its neural network layers, taking into account learned relationships between textual descriptions and numerical patterns. The model generates a natural language output that may include observations about revenue concentration, regional distribution, or differences in profitability among the top entities. The server decodes this output sequence into text and stores it as explanation information associated with the ranked organizational-entity list data. The output of this step is explanation information that contextualizes and interprets the ranking results.

### Step 13:

The server performs emotion analysis to determine an importance index.

The server receives, as input, one or more types of user-related information from the terminal, such as audio information from the user's speech, character information from additional text input, and image information from a camera capturing the user's face. The server applies emotion analysis algorithms to these inputs, extracting features such as vocal tone, textual sentiment indicators, and facial expression patterns. The server combines these features using a fusion model to estimate an emotional state, such as high urgency or low satisfaction. Based on the emotional state, the server computes an importance index that quantifies the priority level of the current instruction. The output of this step is the importance index and the estimated emotional state stored in memory.

### Step 14:

The server adjusts processing and presentation based on the importance index.

The server takes, as input, the ranked organizational-entity list data, the explanation information, and the importance index. For server-side processing, the server may reprioritize queued analytical tasks so that requests with higher importance indices are processed earlier or with more computational resources. For presentation control, the server may determine which parts of the ranking to emphasize or whether to include additional explanatory details.

The server may, for instance, choose to highlight the top 5 entities or simplify the display for a user showing signs of confusion. The output of this step is a presentation plan specifying the order, granularity, and style of information to be delivered to the terminal.

### Step 15:

The server optionally generates additional narrowing or sorting conditions.

The server receives, as input, the emotional state, the usage scenario, and the current ranked organizational-entity list data. When conditions indicate that the user might benefit from a refined view (for example, when the emotional state suggests overload or dissatisfaction), the server generates additional narrowing conditions, such as focusing on a narrower region or on entities above a threshold profit margin. The server may also generate alternative sorting conditions, such as ordering by profit margin instead of revenue. These conditions are encoded as internal rule structures referencing specific attributes and thresholds. The output of this step is a set of additional narrowing conditions and sorting conditions that can be applied to the preprocessed data set.

### Step 16:

The server reprocesses the preprocessed data set using the additional conditions.

The server takes, as input, the preprocessed data set and the additional narrowing and sorting conditions. The server filters the data set according to the new constraints, removing records that do not satisfy the additional filters. The server then reorders the filtered set using the new sorting conditions. As before, the server extracts top elements and reassigns ranks accordingly. This reprocessing transforms the original ranking into an updated ranking that is more aligned with the inferred needs of the user. The output of this step is updated ranked organizational-entity list data.

### Step 17:

The server generates final display data for the terminal.

The server receives, as input, either the original ranked organizational-entity list data or the updated ranked organizational-entity list data, together with associated explanation information and the presentation plan. The server converts these items into a display data format, including structured representations for tables and text blocks. The server arranges the data according to the presentation plan, for example, determining column order, deciding which attributes to show, and selecting emphasis styles. The server outputs a display-ready response message that contains the structured visual data and the explanation text.

### Step 18:

The terminal renders the received data to the user.

The terminal takes, as input, the display-ready response message from the server. The terminal parses the message into UI components and renders a visual table that lists the ranked entities, shows ranks, names, industries, regions, and sales-related values, and displays the explanation information in a separate text area. The terminal may also highlight specific rows or sections according to emphasis instructions. The terminal then displays this information on the screen for the user. The output of this step is the visible user interface presenting the ranking and explanations.

### Step 19:

The user optionally refines the request with additional prompt sentences.

The user observes the displayed ranking and explanation. Based on the presented information, the user may input a new prompt sentence on the terminal, such as “Filter to entities with profit margin above 10%” or “Show only entities in a particular country.” The terminal receives this new prompt sentence, packages it with updated session context and any additional input data, and sends another request message to the server. The output of this step is a refined request that reenters the processing flow starting from the server-side parsing and model interaction.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that route user requests to departments or services suffer from several technical limitations. First, such systems typically rely on static keyword matching or manually configured rule sets operating on raw user text, which leads to poor understanding of complex requests, low routing accuracy, and a high rate of manual escalation. Second, existing platforms generally treat external data sources (such as financial records, organization attributes, and regional statistics) as separate from request-routing logic, thereby failing to automatically generate context-aware scenarios or use cases that can guide downstream processing. Third, although recent systems may incorporate emotion detection as an auxiliary function, they usually do not integrate emotion analysis into the core control flow that governs how computational resources are prioritized, how prompts are constructed for artificial intelligence engines, or how information is structured and delivered back to users. As a result, the underlying computer system does not efficiently allocate processing resources or network bandwidth in response to the semantic content and emotional urgency of incoming information.

Moreover, typical integrations of generative artificial intelligence models are limited to simple question-answering patterns, where user input is directly forwarded as a prompt and the output is returned as unstructured text. Such patterns do not exploit the capability of generative models to synthesize structured use case information conditioned on external attribute data (for example, ranked organizations based on financial indicators, or communication-technology constraints in particular regions), nor do they use feedback signals from terminals to iteratively refine prompt-generation rules and routing rules. Consequently, the computer system cannot automatically evolve its behavior over time, and the quality of generated suggestions and routing decisions remains static even as usage patterns change.

In addition, most existing systems lack a mechanism for dynamically adjusting presentation detail and response ordering based on machine-computed priority scores derived from multi-modal emotion analysis and generated use case importance. Without such a mechanism, a server may process low-urgency requests before high-urgency requests, or may return overly detailed responses when network conditions or device capabilities would favor more compact representations, leading to inefficient use of processing resources and communication channels.

Therefore, there is a need for a computer-implemented system that (i) automatically constructs prompt sentences by combining user input with heterogeneous external attribute data, (ii) invokes a generative artificial intelligence model to synthesize structured use case information for routing and decision support, (iii) applies preset and adaptively updated sorting rules to map requests and generated use cases to appropriate processing units, and (iv) uses multi-modal emotion analysis to compute priority scores and to dynamically control processing order, delivery order, and level of detail in responses. Such a system should improve the functioning of the underlying computer architecture by reducing manual configuration effort, increasing routing accuracy, optimizing utilization of processing and network resources, and enabling learning-based refinement of prompt-generation and routing behavior over time.

The specific processing by the specific processing unit 290 of the data processing device 12 in Application Example 2 is realized by the following means.

The present invention provides a server comprising a processor configured to receive, via an information input/output apparatus, input information including at least one of text information, audio information, image information, and numerical information from a user; to acquire, via at least one of an external database apparatus and a communication interface, external data including at least one of financial data, organization data, regional statistical data, and public data, and to generate target information including attribute information based on the external data; to generate, based on the input information and the target information, a prompt sentence in which summary information and a request content relating to at least one of a target domain, a target organization, a target technology, and a target region are embedded, and to input the prompt sentence to a generative artificial intelligence model so as to cause the generative artificial intelligence model to generate use case information including at least one of advertising measure use cases, communication technology use cases, information delivery scenarios, and business processing scenarios; to analyze the use case information acquired from the generative artificial intelligence model and, based on at least one of business classification information, technology classification information, and target domain classification information, to associate the input information and the use case information with department information or service information in accordance with preset sorting rules so as to sort an information processing request to an appropriate processing unit; to identify, based on the financial data, an upper group of organizations ranked by a sales indicator and to include attribute information relating to the upper group of organizations in the prompt sentence so as to cause the generative artificial intelligence model to generate, as the use case information, at least one of advertising measure use cases and communication technology use cases for the upper group of organizations; to execute emotion analysis processing using at least one of audio information, text information, and facial image information of the user as input, to calculate evaluation values for a plurality of emotion categories to identify a dominant emotional state, and to include the dominant emotional state and the evaluation values in the prompt sentence so as to cause the generative artificial intelligence model to generate emotion-dependent use case information or content delivery scenarios; to calculate, based on the evaluation values and importance information included in the use case information, a priority score for each information processing request and to control at least one of a processing order and a delivery order of the information processing requests according to the priority score; to adjust at least one of an information amount and a level of detail when presenting the generated use case information to the user; and to update, based on evaluation information or feedback information transmitted from a terminal apparatus, at least one of a generation rule of the prompt sentence and the sorting rules so as to improve, in a learning manner, the use case information to be generated and a result of information sorting. This enables the underlying computer system to automatically construct context-rich prompts, to obtain structured and semantically meaningful use case information from the generative artificial intelligence model, to route and prioritize information processing requests with improved accuracy and responsiveness, to adapt the granularity and ordering of responses to both emotional urgency and system conditions, and to iteratively refine its own prompt-generation and routing behaviors based on accumulated feedback, thereby improving the overall efficiency, scalability, and technical performance of the information processing infrastructure.

The term “information input/output apparatus” refers to a hardware and/or software interface component, such as a display, input device, communication interface, or combination thereof, that enables a user to input information to, and receive information from, a computer system.

The term “input information” refers to data provided from a user to a computer system, the data including at least one of text information, audio information, image information, and numerical information.

The term “external database apparatus” refers to a data storage system that is separate from a primary processing device and that can be accessed via a communication network to obtain structured or unstructured data.

The term “communication interface” refers to a hardware and/or software component that establishes and manages data communication between a computer system and an external device or network, using wired or wireless communication protocols.

The term “external data” refers to data acquired from a source outside a primary processing device, including but not limited to financial data, organization data, regional statistical data, and public data.

The term “financial data” refers to data representing economic information of an economic entity, including at least revenue, profit, assets, or similar financial indicators.

The term “organization data” refers to data describing attributes of an organization, including at least identifiers, industry categories, geographic regions, and operational characteristics.

The term “regional statistical data” refers to data that quantitatively describes conditions in a geographic region, including at least population, infrastructure, and economic indicators.

The term “public data” refers to data that is made publicly available through a communication network or other public source and that can be accessed without confidential credentials.

The term “target information” refers to information generated based on external data and representing attributes of at least one of a target domain, a target organization, a target technology, and a target region.

The term “attribute information” refers to descriptive data elements associated with a target, such as category information, ranking information, geographic information, or technical capability information.

The term “prompt sentence” refers to a text sequence that encodes summary information and request content and that is supplied as input to a generative artificial intelligence model to cause the model to generate a response.

The term “generative artificial intelligence model” refers to a computational model that, in response to a prompt sentence, generates new content such as text, structured data, or scenarios, based on parameters learned from training data.

The term “use case information” refers to information describing a scenario in which a technology, service, or process is applied, the information including at least conditions, participants, actions, and expected outcomes.

The term “advertising measure use case” refers to use case information describing an application of communication or marketing activities for promoting products, services, or brands.

The term “communication technology use case” refers to use case information describing an application of communication technologies, including at least wired or wireless communication, for solving a technical or business problem.

The term “information delivery scenario” refers to use case information describing a procedure or sequence for delivering digital information to recipients using communication networks and content distribution mechanisms.

The term “business processing scenario” refers to use case information describing steps, conditions, and decision points of a business process executed by an organization.

The term “business classification information” refers to information indicating a categorization of a request or use case according to a type of business activity or organizational function.

The term “technology classification information” refers to information indicating a categorization of a request or use case according to a type of technology, such as a communication technology, data processing technology, or storage technology.

The term “target domain classification information” refers to information indicating a categorization of a request or use case according to an application field, such as advertising, manufacturing, education, or healthcare.

The term “department information” refers to information identifying a processing unit or organizational unit within a system or organization that is responsible for handling a particular type of request or use case.

The term “service information” refers to information identifying a software service, application module, or external service endpoint that is configured to process certain categories of requests or use cases.

The term “sorting rules” refers to machine-readable rules that specify how to associate input information and use case information with department information or service information for routing and processing.

The term “information processing request” refers to a unit of work derived from input information, representing a request for processing, analysis, or action by a computer system or organizational unit.

The term “upper group of organizations” refers to a subset of organizations selected from a larger set, the subset being ranked higher according to a sales indicator or similar financial metric.

The term “sales indicator” refers to a numeric measurement derived from financial data, representing at least revenue or other sales-related metrics used for ranking organizations.

The term “terminal apparatus” refers to a computing device operated by a user, such as a mobile device, personal computer, or embedded client, that communicates with a server through a communication network.

The term “operation information” refers to information representing user operations on a terminal apparatus, including at least selections, commands, and input values transmitted to a server.

The term “structured display data” refers to data formatted into a defined structure, such as fields, lists, or hierarchical elements, suitable for presentation on a user interface of a terminal apparatus.

The term “evaluation information” refers to information indicating an assessment or rating of generated use case information by a user, including at least selection results, scores, or comments.

The term “feedback information” refers to information provided by a user or another system that indicates a reaction to or quality of generated outputs, and that is used to adjust processing behavior.

The term “generation rule of the prompt sentence” refers to a rule that defines how to construct a prompt sentence from input information, target information, emotion information, or other context.

The term “emotion analysis processing” refers to processing that estimates emotional states of a user based on at least audio information, text information, or facial image information.

The term “emotion category” refers to a type of emotion, such as joy, anger, sadness, fear, or similar states, used as a label for emotion analysis.

The term “evaluation value” refers to a numeric or symbolic value indicating a strength or likelihood of a particular emotion category for a given input.

The term “dominant emotional state” refers to an emotion category selected as most representative for an input based on evaluation values across multiple emotion categories.

The term “emotion-dependent use case information” refers to use case information generated in dependence on a detected emotional state, such that the scenario content is adapted to the emotional state.

The term “content delivery scenario” refers to a scenario describing how digital content is selected, formatted, transmitted, and presented to a user through a communication network.

The term “importance information” refers to data indicating a relative importance, urgency, or impact associated with a use case or request, which may be embedded in or derived from use case information.

The term “priority score” refers to a computed value representing a relative priority of an information processing request, calculated based on at least emotion analysis results and importance information.

The term “processing order” refers to an order in which a server or other processing resource executes multiple information processing requests.

The term “delivery order” refers to an order in which responses or content are transmitted or presented to users or external systems.

The term “information amount” refers to a quantity or volume of information included in a response, such as the number of items, length of text, or number of details.

The term “level of detail” refers to a granularity or specificity of information included in a response, such as whether content is provided in summary form or with technical details.

The term “learning manner” refers to a mode of operation in which a system modifies internal parameters, rules, or models based on accumulated data, feedback, or performance outcomes over time.

In an embodiment, a server, a terminal, and a user cooperate to implement the claimed system.

The server includes at least one processor, a volatile and non-volatile memory, a network interface, and access to one or more external database apparatuses via a communication network.

The terminal includes at least one processor, a memory, a display, a user input device, at least one of a microphone and a camera, and a communication interface.

The user operates the terminal to provide input information and to receive use case information.

The server executes software modules implemented, for example, in a programming language such as Python running on an operating system such as a general-purpose server operating system.

The server uses software libraries such as a numerical computation library, a data-frame library, and a natural language processing library to perform data transformations.

The server communicates with external data sources through network protocols such as HTTPS using a communication interface.

The terminal executes a client application implemented, for example, as a mobile or desktop application using a graphical user interface framework.

The terminal acquires user input information via the display and the input device, and acquires audio information and image information via the microphone and the camera.

The terminal transmits the acquired input information to the server via the communication interface and receives structured display data from the server.

The server acquires external data from an external database apparatus or another external information source.

The server stores financial data, organization data, regional statistical data, and public data in a structured data store such as a relational database.

The server constructs target information by aggregating and normalizing these external data sets, including attribute information such as sales indicators, industry categories, and regional conditions.

The server generates a prompt sentence based on the input information and the target information.

The server constructs the prompt sentence as a natural language sequence in which summary information of at least one of a target domain, a target organization, a target technology, and a target region is embedded together with a request content.

The server applies a prompt-generation rule that selects and orders fields of the input information and the target information according to a predefined template and rule weights, so that important attributes such as high sales ranking or severe network constraints are emphasized at the beginning of the prompt sentence.

The server uses a generative AI model deployed on the same hardware as the server or on a remote computing resource.

The server implements the generative AI model as a neural network including an embedding layer, multiple attention layers, and an output projection layer, corresponding to a transformer-type language model.

The server initializes the generative AI model with parameters obtained by pre-training on a large corpus of text and further adapts the parameters by fine-tuning on domain-specific prompt-response pairs, including advertising measure use cases and communication technology use cases.

The server represents each token of the prompt sentence as a high-dimensional vector using the embedding layer of the generative AI model.

The server processes the token vectors through multi-head self-attention layers, where each attention head computes weighted sums of other token vectors according to learned attention scores.

The server uses layer normalization and residual connections to stabilize the forward propagation and to improve convergence.

The server trains or fine-tunes the generative AI model using a sequence-to-sequence learning objective.

The server defines a loss function as a cross-entropy error between predicted next tokens and ground-truth next tokens for training sequences derived from historical prompt sentences and desired use case information.

The server updates the model weights by gradient-based optimization, such as stochastic gradient descent with adaptive moment estimation, using batched training data.

The server optionally applies regularization techniques such as dropout on attention weights and data augmentation on textual inputs to reduce overfitting and to improve generalization.

The server, during inference, inputs the constructed prompt sentence into the generative AI model and generates use case information as a sequence of tokens decoded from the model output.

The server constrains the decoding by using a sampling strategy such as top-k sampling or nucleus sampling, and by enforcing the presence of control tokens or markers for sections such as “Technology:”, “Devices:”, and “Impact:”.

The server thereby obtains use case information that is more structured and more easily parsed than free-form text.

The server analyzes the generated use case information using a natural language processing module.

The server identifies sections of the use case information based on keywords and structural markers, and the server maps each section to data fields in an internal data structure.

The server constructs business classification information, technology classification information, and target domain classification information by applying a classifier that has been trained on labeled examples of use cases.

The server associates the input information and the use case information with department information or service information according to sorting rules.

The server implements the sorting rules as a rule table and a rule evaluation engine, where each rule specifies one or more classification conditions and a corresponding target department or service.

The server evaluates the classification information of the use case information against the rule table and selects one or more processing units as destinations for the information processing request.

The server acquires financial data from an external database apparatus and determines an upper group of organizations based on a sales indicator.

The server sorts organization records by revenue or another sales-related metric and selects the top records to form an upper group of organizations.

The server includes attribute information of the upper group of organizations, such as industry, scale, and geographic region, into the prompt sentence, thereby causing the generative AI model to generate advertising measure use cases or communication technology use cases that are tailored to the upper group of organizations.

The terminal transmits operation information indicating user selections of organization information, regional information, or industry information to the server.

The server stores these selections together with the generated use case information in a persistent data store.

The server generates structured display data from the stored use case information, including headings, bullet lists, and field values, and transmits the structured display data to the terminal.

The terminal displays the structured display data on the display in sections so that the user can easily review the generated use case information.

The terminal allows the user to input evaluation information or feedback information such as ratings, comments, or labels indicating usefulness or correctness.

The terminal transmits the evaluation information or feedback information to the server via the communication interface.

The server receives the evaluation information or feedback information from the terminal and updates at least one of the generation rule of the prompt sentence and the sorting rules.

The server applies a learning algorithm that adjusts rule weights and selection thresholds based on aggregated feedback records.

The server updates internal statistics of which prompt structures and which rule branches led to high evaluation scores and, conversely, which branches led to low evaluation scores.

The server thereby modifies the order and content of subsequent prompt sentences and modifies the mapping from classification information to departments or services, so that the system adaptively improves over time.

The server executes emotion analysis processing on audio information, text information, and facial image information acquired from the terminal.

The server uses an acoustic feature extractor to compute features such as pitch, energy, and spectral properties from audio information.

The server uses a text sentiment analysis module to compute lexical and syntactic features from text information.

The server uses an image processing module, implemented for example with a convolutional neural network, to derive facial expression features from facial image information.

The server combines the acoustic, textual, and facial features into a feature vector and inputs the feature vector into an emotion classification model.

The server implements the emotion classification model as a neural network with an input layer for multi-modal features, one or more hidden layers, and an output layer that outputs evaluation values for a plurality of emotion categories.

The server identifies a dominant emotional state as an emotion category corresponding to a maximum evaluation value.

The server includes the dominant emotional state and the evaluation values in the prompt sentence so that the generative AI model generates emotion-dependent use case information or content delivery scenarios.

The server explicitly encodes the emotional context at the beginning of the prompt sentence, for example by embedding phrases such as “The user currently feels joy and frustration regarding connectivity.”

The server thus modifies the internal attention distribution of the generative AI model, because tokens corresponding to emotional context obtain higher attention weights during generation.

The server calculates a priority score for each information processing request based on the evaluation values from the emotion analysis processing and importance information included in the use case information.

The server uses a priority calculation function that may be a linear combination or a non-linear function of emotion intensity and use-case importance values.

The server assigns higher priority scores to information processing requests associated with urgent emotional states or high criticality use cases.

The server uses the priority scores to control the processing order and the delivery order of information processing requests.

The server schedules computational tasks in a task queue so that tasks with higher priority scores are processed earlier by the processor.

The server also adjusts the order in which responses are transmitted back to terminal devices, causing high-priority responses to be transmitted first.

The server adjusts an information amount and a level of detail of the generated use case information when presenting the use case information to the user.

The server reduces the amount of information and provides concise summaries when network conditions are poor, terminal capabilities are limited, or emotion analysis indicates that the user requires rapid, high-level guidance.

The server increases the level of detail and includes more technical explanation when emotion analysis and user profile indicate that the user desires detailed analysis.

The server, by using the generative AI model and prompt sentence construction as described above, improves internal computer operations beyond mere automation of human tasks.

The server reduces manual configuration effort because the generative AI model synthesizes structured use case information and classification hints that are not directly derivable from raw user text by simple keyword matching.

The server reduces processing time for routing decisions because the sorting rules operate on machine-generated, normalized classification fields rather than on unstructured strings, enabling faster lookups and comparisons.

The server improves memory utilization and data management by storing generated use case information in a structured format that allows efficient indexing and retrieval.

The server reduces communication load between the server and the terminal by adapting the information amount and by sending structured display data rather than redundant text blocks.

The server increases accuracy of routing to processing units because the priority scores and classification information are derived from multi-modal emotion analysis and external attribute data, which a human operator cannot realistically combine at the same scale and speed.

The server provides an improvement in technical functionality of the computing infrastructure by dynamically adjusting scheduling and serialization of requests according to calculated priority scores, thereby reducing response times for critical requests.

The server and the terminal are applicable in various concrete use environments.

The server may operate in an environment where advertising strategies are generated for organizations with high sales, and where communication technology use cases are generated for regions with limited infrastructure.

The server may operate in an environment where real-time status of manufacturing equipment is monitored and where generative AI use cases are used to adjust communication settings and processing priorities for machines.

The terminal may be implemented as an industrial controller, a mobile communication device, or a workstation display terminal.

The user may enter a prompt such as:

“The IT industry's top 10 companies by revenue are the targets. Based on past campaign data and current market trends, propose optimal advertising strategies for these companies.”

The user may enter a prompt such as:

“In a rural region with low wired infrastructure and partial wireless coverage, propose communication-technology use cases to improve the education environment.”

The user may enter a prompt such as:

“The user feels joy when watching high-quality movies and anger when the internet connection is unstable. Generate Private 5G use cases that enhance the joyful experience and reduce anger.”

The server, by applying the described modules and algorithms, generates use case information responsive to these prompt sentences in a technically controlled manner. Alternative embodiments are possible.

The server may use a different type of generative AI model, such as a recurrent neural network, provided that the model receives a prompt sentence and generates use case information.

The server may implement the emotion classification model as a decision tree or a support vector machine, rather than a neural network, as long as evaluation values for emotion categories are produced.

The server may modify the structure of the sorting rules, such as by using a graph-based routing table or a learned policy network, while still mapping classification information to department information or service information.

The terminal may provide different user interfaces, such as voice-only interfaces or augmented reality displays, while still acquiring input information and presenting structured display data.

The external database apparatus may be implemented as a relational database, a key-value store, or a distributed file system, provided that the server acquires external data in a structured way.

The system may be deployed on a single physical server, on a virtualized cluster, or on a distributed cloud infrastructure.

In all these embodiments, the server, the terminal, and the user cooperate to implement a specific technical solution in which the server constructs context-rich prompt sentences, invokes a generative AI model to generate structured use case information, analyzes and routes the information according to technical classification and emotion-based priority, and adapts data representation and scheduling to improve computational efficiency and responsiveness.

The described configurations and algorithms provide a practical implementation that can be carried out by a person skilled in the art using general-purpose or specialized computing hardware and software.

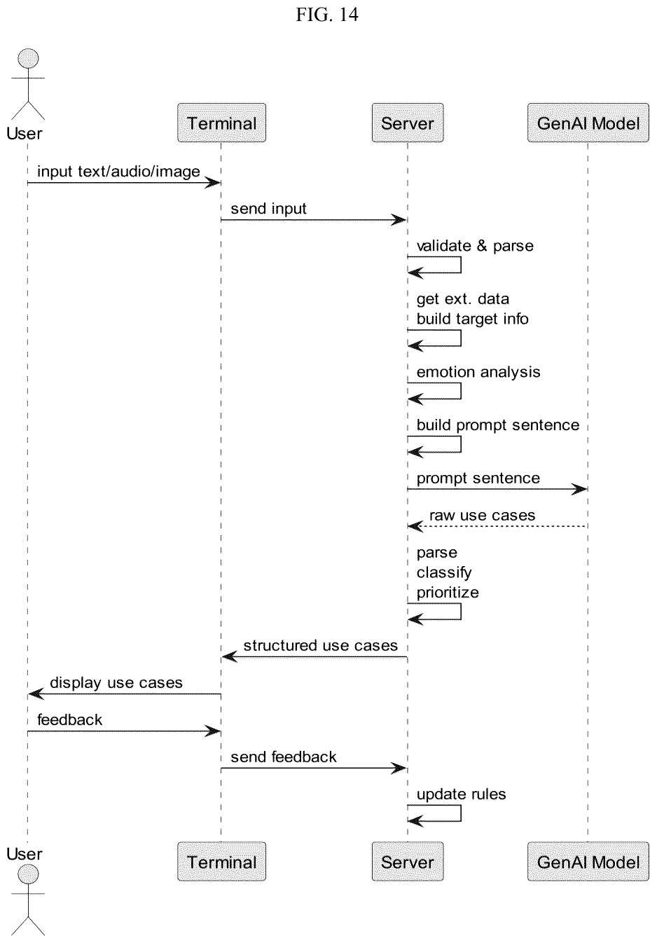

The following describes the processing flow using FIG. 14.

### Step 1:

The user operates the terminal to input information.

The user enters text information, such as a question or requirement, selects one or more items such as industries or regions from a list displayed on the terminal, and optionally records audio information or allows the camera to capture facial image information.

The terminal receives this input as raw data (input: user text, audio stream, image frames, selection values) and stores the raw data in a temporary memory area.

The terminal converts the audio stream into a digital audio buffer using an audio interface and converts image frames into compressed image data using an image encoder.

The terminal outputs a unified input dataset containing the text string, encoded audio data, encoded image data, and selected option values.

### Step 2:

The terminal transmits the unified input dataset to the server.

The terminal packages the input dataset into a request message including metadata such as user identifier and timestamp (input: unified input dataset) and encrypts the message using a network security protocol.

The terminal sends the encrypted message through a communication interface using a network protocol such as HTTPS.

The terminal outputs a network packet stream that carries the user input to the server.

### Step 3:

The server receives and validates the user input.

The server accepts the network packet stream from the communication interface and reconstructs the request message (input: encrypted request message) by performing decryption and integrity verification.

The server parses the message to separate text information, audio data, image data, and selection values, and checks for required fields and data formats.

The server outputs validated user input data structures, including a text string, binary audio buffer, binary image buffer, and structured selection parameters.

### Step 4:

The server acquires external data and constructs target information.

The server issues queries to at least one external database apparatus or external service using the selection parameters as keys or filters (input: selection parameters such as industry, region, or organization identifiers).

The server retrieves external data, such as financial records, organization attributes, and regional statistics, and maps these records into internal data frames or tables.

The server applies data processing operations, including type conversion, normalization, and aggregation, to compute attribute information such as sales ranks, industry categories, and regional constraints.

The server outputs target information objects that summarize external attributes relevant to the user input.

### Step 5:

The server performs emotion analysis processing on multi-modal user data.

The server extracts acoustic features such as pitch, energy, and spectral coefficients from the audio buffer (input: audio buffer) using a signal processing module and outputs an acoustic feature vector.

The server performs text preprocessing on the user text, including tokenization and normalization, to feed a text sentiment analyzer (input: user text) and outputs a textual emotion feature vector.

The server runs an image analysis module, such as a convolutional neural network, on the facial image data (input: image buffer) to compute facial expression features and outputs a facial feature vector.

The server concatenates the acoustic, textual, and facial feature vectors into a multi-modal feature vector and inputs this vector to an emotion classification model.

The server computes evaluation values for a plurality of emotion categories and selects a dominant emotional state (output: set of evaluation values and dominant emotional state).

### Step 6:

The server generates a prompt sentence for the generative AI model.

The server combines the user text, the target information, and the emotion analysis result (input: validated user input, target information, dominant emotional state, evaluation values) according to a predefined prompt-generation rule.

The server selects key fields such as top organizations by sales, regional constraints, and current dominant emotional state, orders them by importance, and formats them as natural language using templates.

The server produces a prompt sentence such as:

“The user currently feels joy when watching high-quality videos and anger when network disconnections occur. In a region where the top 10 organizations by sales operate in the information industry, and where network coverage is limited, generate detailed communication-technology use cases that improve reliability and user satisfaction.”

The server outputs the constructed prompt sentence as a string ready for input to the generative AI model.

### Step 7:

The server invokes the generative AI model and generates use case information.

The server passes the prompt sentence to the generative AI model via an inference API (input: prompt sentence) and sets decoding parameters such as maximum output length and sampling configuration.

The server causes the generative AI model to perform token embedding, multi-head attention, and output projection operations internally, thereby computing probability distributions over next tokens and generating a sequence of tokens that represents use case information.

The server decodes the token sequence back into a text representation containing scenario descriptions, technical requirements, and expected impacts.

The server outputs raw generated text that represents the use case information.

### Step 8:

The server parses and structures the generated use case information.

The server analyzes the raw generated text (input: generated text) using natural language processing tools to detect headings, lists, and key markers such as “Technology:”, “Devices:”, and “Impact:”.

The server splits the text into multiple use case units and extracts fields such as title, target domain, required technology, device requirements, and impact description for each unit.

The server assigns business classification labels, technology classification labels, and target domain classification labels by applying a trained classifier to each use case unit.

The server outputs a structured use case dataset where each use case is represented by a record with defined fields and classification labels.

### Step 9:

The server computes priority scores and applies sorting rules.

The server computes a priority score for each information processing request (input: evaluation values from emotion analysis, importance information derived from the structured use case dataset) by applying a priority function that combines emotion intensity and use-case criticality.

The server uses the classification labels and the structured fields of the use case dataset (input: structured use case dataset) to evaluate sorting rules stored in a rule table.

The server determines department information or service information to which the information processing request and each use case should be routed.

The server orders the information processing requests according to the priority scores and assigns each request to one or more processing units (output: routing decisions and prioritized queue entries).

### Step 10:

The server generates structured display data for the terminal.

The server transforms the structured use case dataset and routing decisions (input: structured use cases, routing decisions, priority scores) into display-oriented data structures, such as nested lists with headings and summarized fields.

The server adjusts the information amount and level of detail based on the priority scores, emotion state, and optionally network conditions, for example by including full technical detail for high-priority technical users and summarized content for urgent non-technical users.

The server serializes this display-oriented data into a response message and attaches metadata such as processing time and model version.

The server outputs the response message containing structured display data destined for the terminal.

### Step 11:

The terminal receives and presents the structured display data.

The terminal accepts the response message from the server (input: structured display data with metadata) via the communication interface and parses the serialized content into internal UI objects.

The terminal generates user interface components such as lists, detail views, and tabs to display use case titles, technologies, impacts, and associated departments or services.

The terminal may visually highlight high-priority items based on the priority scores and may provide controls for filtering or expanding detailed sections.

The terminal outputs a graphical presentation on the display and, if applicable, audio prompts indicating new high-priority information.

### Step 12:

The user reviews the generated use case information and provides feedback.

The user inspects the displayed use cases and routing information on the terminal (input: rendered UI) and selects items that appear useful or not useful, or enters comments or ratings through the input device.

The terminal records the evaluation information and feedback information, associates it with corresponding use case identifiers and routing decisions, and creates a feedback dataset.

The terminal transmits the feedback dataset to the server via the communication interface (output: feedback message containing ratings, comments, and context).

### Step 13:

The server updates prompt-generation rules and sorting rules based on feedback.

The server receives the feedback message (input: feedback dataset) and stores the feedback in a feedback repository together with the associated prompt sentence, structured use case records, and routing decisions.

The server computes statistical measures, such as average rating per prompt pattern and per rule branch, and identifies patterns where generated information or routing decisions consistently receive low scores.

The server adjusts parameters of the prompt-generation rule (for example, weights deciding which attributes to emphasize in the prompt sentence) and modifies sorting rule thresholds or mappings to departments based on feedback correlations.

The server outputs updated internal rule sets and configuration parameters that will be used in subsequent executions, thereby improving future generation quality and routing accuracy.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

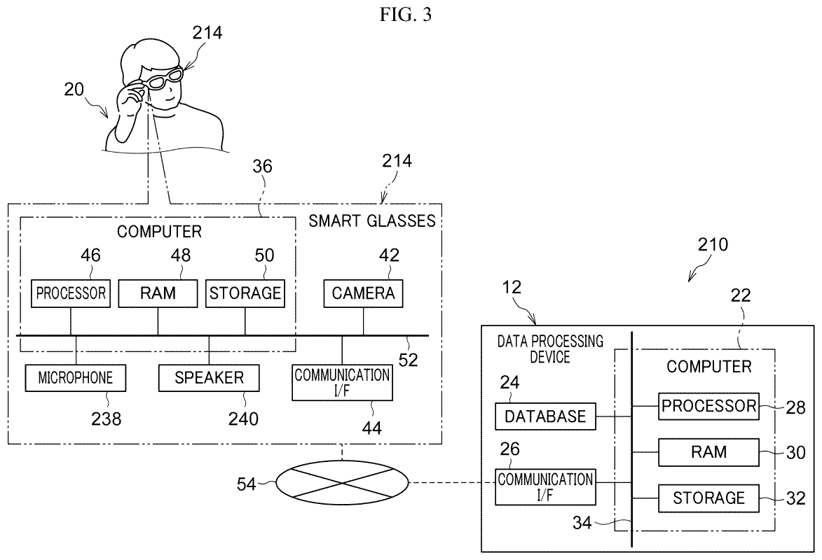

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

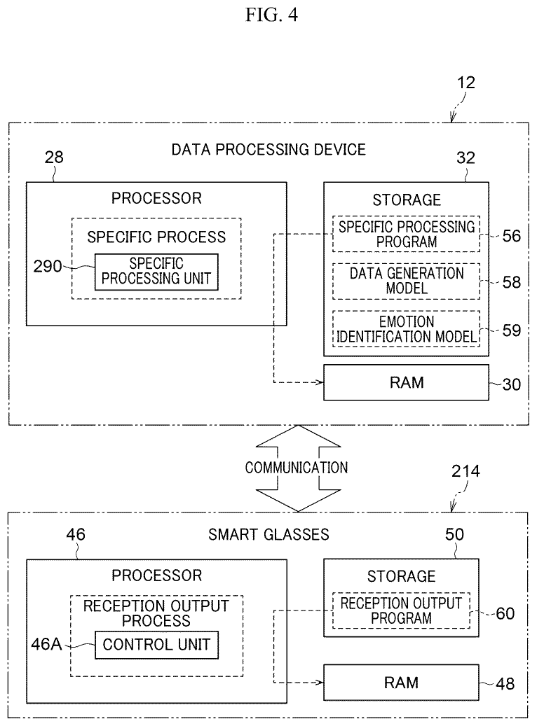

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

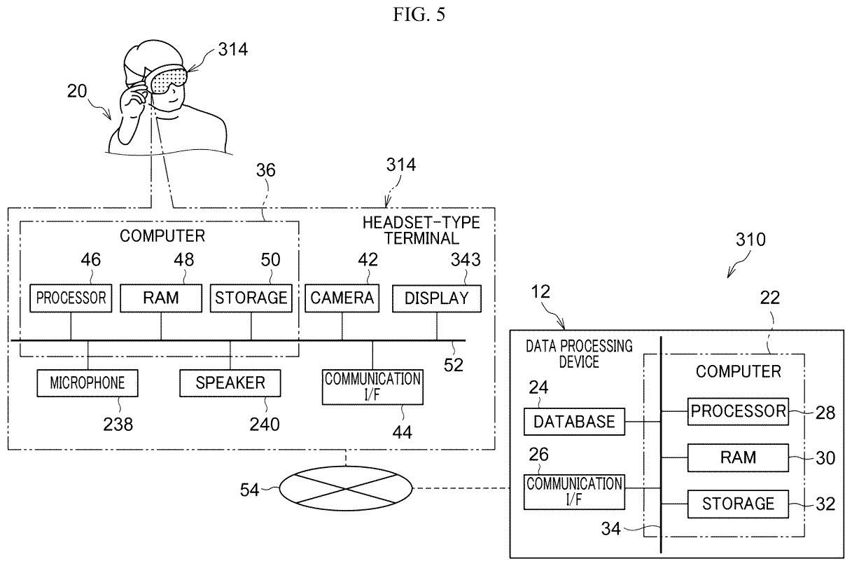

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

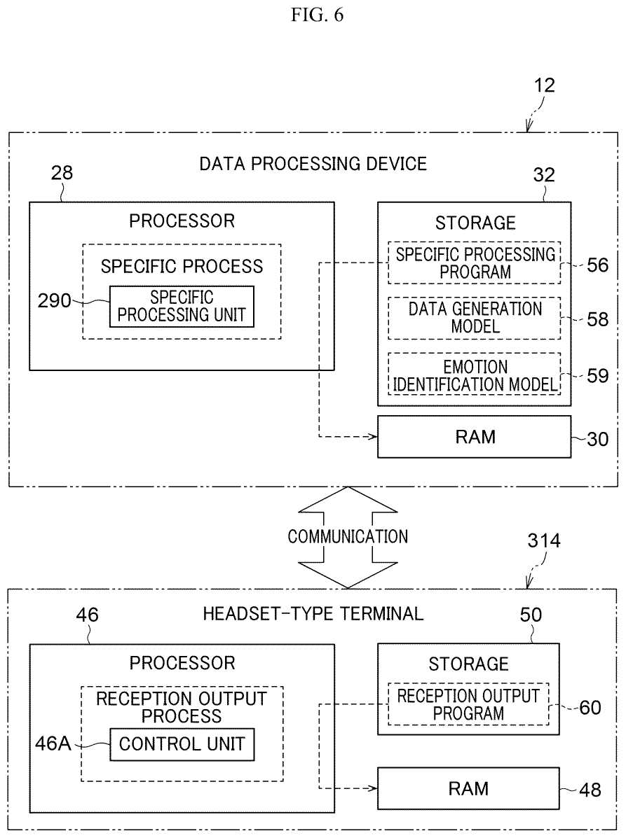

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

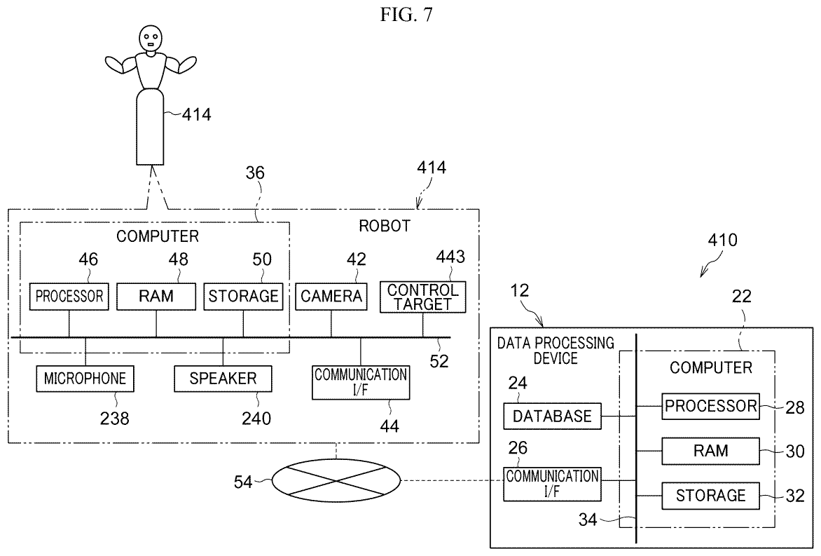

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

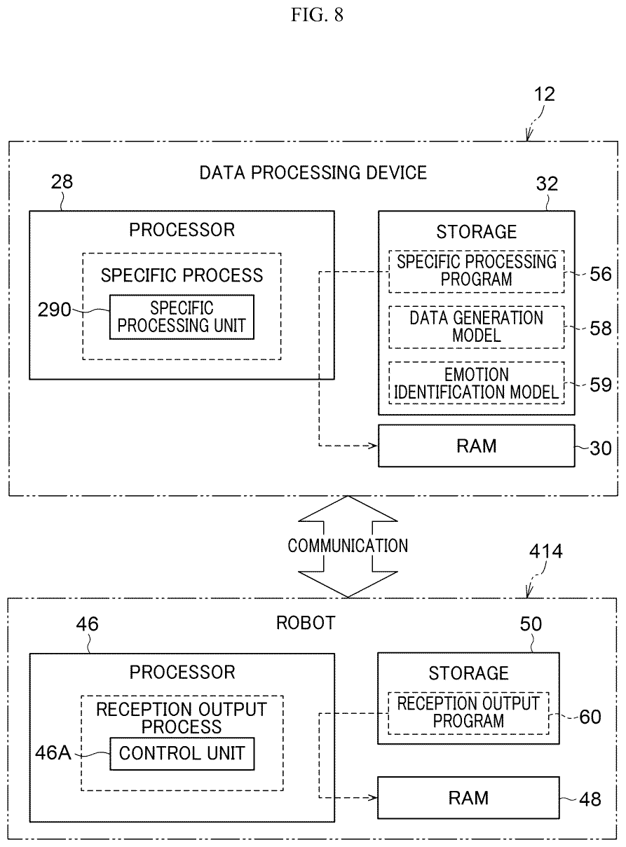

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

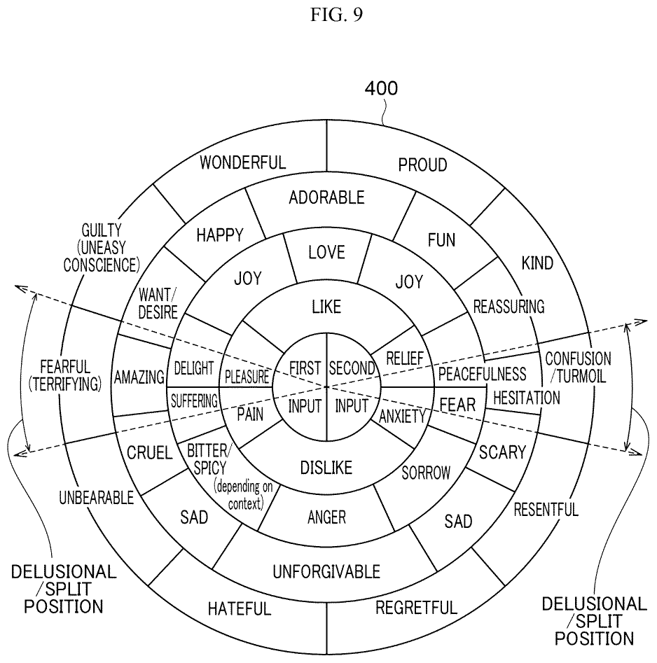

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

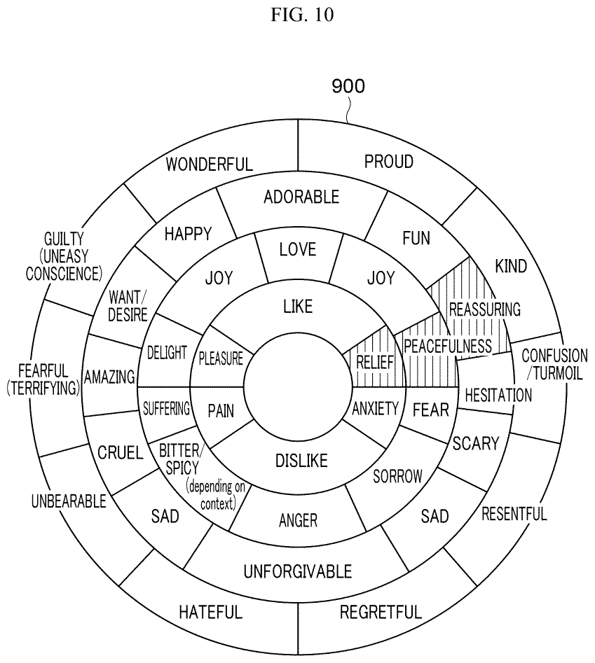

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
access, via a communication network, a plurality of information providing devices and automatically collect unstructured document information from public information sources based on acquisition target identification information, so as to obtain document information including text related to use cases and communication technologies,
extract character information from the collected document information, perform language type determination processing on the character information, perform machine translation processing when a predetermined language condition is satisfied, execute a natural language processing program including a generative AI model on the character information, extract organization information and case information related to overseas use cases and utilization of wireless communication technologies, and calculate, based on the organization information and the case information, an activity index for each organization and identify organizations having active utilization of wireless communication technologies in overseas regions, generate, based on the identified organizations and the case information, summary information in which attribute information including industry type, geographic region, technology type, and the activity index is organized, and store the summary information as structured information that is transmittable to an external device in the storage device, execute a prompt sentence generation process that instructs the generative AI model to automatically generate question-type prompt sentences to be used as input sentences to the generative AI model on the basis of the summary information and the structured information, and generate, by the prompt sentence generation process, a plurality of prompt sentence candidates including inquiry contents related to the overseas use cases and the organizations utilizing the wireless communication technologies,
provide, in response to a request from an external terminal, the plurality of prompt sentence candidates and the summary information regarding the identified organizations to the external terminal, receive, from the external terminal, a selected or edited prompt sentence among the plurality of prompt sentence candidates, and transmit the selected or edited prompt sentence to the generative AI model, and
acquire, from the generative AI model, response information corresponding to the selected or edited prompt sentence and provide the response information to the external terminal.

### (Supplementary 2)

The system according to supplementary 1,
wherein the processor is configured to
execute the natural language processing program so as to extract, from the document information, words and phrases representing organization names, technology names, region names, industrial sectors, and case contents, integrate identical organizations and identical cases based on semantic representations and similarity calculations performed by the generative AI model, and generate occurrence frequency information and relevance information to be used for calculating the activity index.

### (Supplementary 3)

The system according to supplementary 1,
wherein the processor is configured to
execute the prompt sentence generation process so as to generate, based on the summary information and the activity index, a plurality of question-type prompt sentences in which inquiry conditions including target industry, target region, target technology, and time period condition are varied, thereby enabling a user to make inquiries, for business decision-making, regarding overseas use cases and application proposals of wireless communication technologies.

### Application Example 1

### (Supplementary 1)

A system comprising a processor,
wherein the processor is configured to
receive information from a user via an information acquisition interface, and acquire document data from information resources via a communication network as public information, perform structural analysis and removal of unnecessary elements on the document data to normalize the document data as text data, and store the normalized text data in a storage unit as information collection processing, and
divide the text data into input segments, generate a prompt sentence that instructs a generative AI model to extract and structure case information and organization information related to communication technology from the input segments, input the prompt sentence and the input segments into the generative AI model to obtain case information, and store the obtained case information in the storage unit as structured data including attribute information as case extraction processing, and
record business type information, region information, and past inquiry history of the user or a usage entity, generate a prompt sentence for inputting the business type information, the region information, and the past inquiry history to the generative AI model, supply the prompt sentence to the generative AI model to estimate feature values and areas of interest regarding the business type information, and update the case information in the storage unit in association with the feature values and the areas of interest as business-type learning processing, and
obtain the feature values and the areas of interest updated by the business-type learning processing and the case information, generate a prompt sentence that instructs the generative AI model to generate application case information of a specific communication technology, input the prompt sentence to the generative AI model to obtain new case information, and store the obtained new case information in the storage unit in a same format as the structured data as automatic case generation processing, and
extract context information including a work environment of the user, a target technology, a target region, and prioritized operational indicators based on the information received from the user, generate a prompt sentence that instructs the generative AI model to select and summarize case information suitable for a request of the user based on the context information and the case information stored in the storage unit, input the prompt sentence to the generative AI model to obtain an output, convert the obtained output into output data in a short-sentence and bullet-point format suitable for browsing on a display device, as response generation processing, and
transmit the output data generated by the response generation processing to the display device, lay out the output data into a format that is successively displayable on a visual interface of the display device, and present the output data in a position superimposed within a field of view of the user during work as display control processing, and
acquire subsequent inquiries and selection operations from the user via the information acquisition interface, and dynamically update the prompt sentence and case selection conditions by inputting the subsequent inquiries and the selection operations again to the business-type learning processing and the response generation processing, as feedback learning processing.

### (Supplementary 2)

The system according to supplementary 1,
wherein the processor is configured to
classify the normalized text data by assigning category information including a communication scheme, an application field, and a regional classification as classification processing in the information collection processing, and select, in the case extraction processing, the text data to be input to the generative AI model based on the category information assigned by the classification processing.

### (Supplementary 3)

The system according to supplementary 1,
wherein the processor is configured to
acquire state information of the user, change conditions concerning output length, level of detail, and presentation order in the prompt sentence based on the state information, calculate a display priority score for an output obtained from the generative AI model, and control, by the display control processing, a display order and a display time of the output data according to the display priority score.

### Example 2

### (Supplementary 1)

A system comprising a processor,
wherein the processor is configured to
receive information from a user via an information input/output device, generate a prompt sentence for instructing a generative AI model to generate a related usage scenario for analyzing a natural language instruction included in the received information, input the prompt sentence into the generative AI model, and obtain, from the generative AI model, the usage scenario and data acquisition conditions and data processing conditions corresponding to the usage scenario,
acquire structured data including financial information of an organizational entity by making an inquiry, on the basis of the data acquisition conditions, to a database management mechanism operating on an information processing apparatus,
generate a preprocessed data set by performing preprocessing including missing-value processing, abnormal-value removal, and attribute-value conversion on the structured data by using a general-purpose information processing language and a data-processing program component on the basis of the data processing conditions,
generate ranked organizational-entity list data by performing sorting processing in descending order on the basis of an attribute related to sales and performing extraction processing of upper elements on the preprocessed data set to identify organizational entities having high sales,
generate an additional prompt sentence for instructing the generative AI model to perform summary generation or trend analysis on the basis of the ranked organizational-entity list data and the usage scenario, and obtain explanation information from the generative AI model, and
convert the ranked organizational-entity list data and the explanation information into a display data format that is outputtable to the information input/output device, and present the ranked organizational-entity list data and the explanation information to the user via the information input/output device.

### (Supplementary 2)

The system according to supplementary 1,
wherein the processor is configured to
perform emotion analysis processing that evaluates an emotional state of the user using at least one of audio information, character information, and image information acquired via the information input/output device, calculate an importance index of the information received from the user on the basis of the emotional state, and control a presentation order or a presentation mode of the ranked organizational-entity list data and the explanation information in accordance with the importance index.

### (Supplementary 3)

The system according to supplementary 1,
wherein the processor is configured to
automatically generate an additional narrowing condition or a sorting condition for the financial information of the organizational entity on the basis of a result of the emotion analysis processing and the usage scenario obtained from the generative AI model, reprocess the preprocessed data set on the basis of the additional narrowing condition or the sorting condition to generate updated ranked organizational-entity list data, and present the updated ranked organizational-entity list data again to the user via the information input/output device.

### Application Example 2

### (Supplementary 1)

A system comprising a processor,
wherein the processor is configured to
receive, via an information input/output apparatus, input information including at least one of text information, audio information, image information, and numerical information from a user,
generate, based on the input information and target information including attribute information acquired from an external information source, a prompt sentence in which summary information and a request content relating to at least one of a target domain, a target organization, a target technology, and a target region are embedded, and input the prompt sentence to a generative artificial intelligence model so as to cause the generative artificial intelligence model to generate use case information including at least one of advertising measure use cases, communication technology use cases, information delivery scenarios, and business processing scenarios,
analyze the use case information acquired from the generative artificial intelligence model, and, based on at least one of business classification information, technology classification information, and target domain classification information, associate the input information and the use case information with department information or service information in accordance with preset sorting rules so as to sort an information processing request to an appropriate processing unit,
acquire, via at least one of an external database apparatus and a communication interface, external data including at least one of financial data, organization data, regional statistical data, and public data, identify an upper group of organizations ranked by a sales indicator based on the financial data, and include attribute information relating to the upper group of organizations in the prompt sentence so as to cause the generative artificial intelligence model to generate, as the use case information, at least one of advertising measure use cases and communication technology use cases for the upper group of organizations,
store, based on operation information transmitted from a terminal apparatus, at least one of selected organization information, regional information, and industry information in association with the use case information acquired from the generative artificial intelligence model, and transmit the use case information to the terminal apparatus as structured display data, and
update, based on evaluation information or feedback information transmitted from the terminal apparatus, at least one of a generation rule of the prompt sentence and the sorting rules, so as to improve, in a learning manner, the use case information to be generated and a result of information sorting.

### (Supplementary 2)

The system according to supplementary 1,
wherein the processor is configured to
execute emotion analysis processing using at least one of audio information, text information, and facial image information of a user as input, calculate evaluation values for a plurality of emotion categories to identify a dominant emotional state, and include the dominant emotional state and the evaluation values in the prompt sentence so as to cause the generative artificial intelligence model to generate, as the use case information, at least one of emotion-dependent use case information and content delivery scenarios.

### (Supplementary 3)

The system according to supplementary 1,
wherein the processor is configured to
calculate, based on the evaluation values obtained by the emotion analysis processing and importance information included in the use case information, a priority score for each information processing request, control at least one of a processing order and a delivery order of the information processing requests according to the priority score, and adjust at least one of an information amount and a level of detail when presenting the generated use case information to the user.

What is claimed is:

1. A system comprising:
circuitry configured to:
access, via a communication interface coupled to a packet-switched network, a plurality of information providing devices and collect unstructured document information from external sources based on acquisition target identification information;
extract character information from the collected document information, perform language type determination and machine translation processing to normalize the character information, and execute a natural language processing algorithm including a generative neural network model to extract organization information and case information from the normalized character information;
calculate, based on the extracted organization information and the case information, an activity index for each identified organization and identify organizations satisfying an activity threshold;
generate summary information associating attribute information comprising industry type, geographic region, technology type, and the activity index for each identified organization, and store the summary information as structured information in a storage device;
execute a prompt sentence generation process that instructs the generative neural network model to generate a plurality of prompt sentence candidates based on the summary information and the structured information; and
transmit the plurality of prompt sentence candidates and the summary information via the communication interface to a terminal device, receive a selected or edited prompt sentence from the terminal device, transmit the selected or edited prompt sentence to the generative neural network model, and return response information from the generative neural network model to the terminal device.

2. The system according to claim 1, wherein the circuitry is configured to perform language type determination by applying a language identification classifier to the collected document information, and to apply a machine translation model to normalize non-native-language content into a target language prior to natural language processing.

3. The system according to claim 2, wherein the circuitry is configured to apply a named entity recognition algorithm to the normalized character information to identify organization names, geographic regions, and technology type labels, and to store extracted entities as structured records in the storage device.

4. The system according to claim 3, wherein the circuitry is configured to calculate the activity index for each organization based on a frequency of occurrence of the organization in case information records, a recency weight of corresponding document information, and a technology diversity score derived from the technology type labels.

5. The system according to claim 4, wherein the circuitry is configured to rank identified organizations in descending order of activity index and to select a subset of organizations satisfying the activity threshold for inclusion in the summary information.

6. The system according to claim 1, wherein the circuitry is configured to generate the plurality of prompt sentence candidates as question-type sentences that, when submitted to the generative neural network model, elicit responses describing use cases, deployment contexts, or technical approaches associated with the summary information.

7. The system according to claim 6, wherein the circuitry is configured to transmit the plurality of prompt sentence candidates to the terminal device for user review, receive an edited prompt sentence comprising user modifications to a selected candidate, and transmit the edited prompt sentence to the generative neural network model.

8. The system according to claim 7, wherein the circuitry is configured to store the edited prompt sentence and the corresponding response information from the generative neural network model as a prompt-response pair in the storage device.

9. The system according to claim 8, wherein the circuitry is configured to retrieve stored prompt-response pairs from the storage device and incorporate retrieved pairs into subsequently generated prompt sentence candidates to improve contextual relevance of generated responses.

10. The system according to claim 1, wherein the circuitry is configured to receive information from a user terminal, generate a prompt sentence that instructs the generative neural network model to derive a use case interpretation from the received information, and apply a predetermined routing rule to classify the received information into a processing category based on the derived use case.

11. The system according to claim 10, wherein the circuitry is configured to obtain emotion-state information of a user by processing at least one of voice data, text data, and facial expression data received from the terminal device using an emotion recognition model.

12. The system according to claim 11, wherein the circuitry is configured to calculate a priority score for the received information based on the emotion-state information, and to determine a processing order for the received information based on the priority score.

13. The system according to claim 12, wherein the circuitry is configured to adjust the prompt sentence based on the emotion-state information to instruct the generative neural network model to generate a use case interpretation that accounts for an urgency level indicated by the emotion-state information.

14. The system according to claim 1, wherein the circuitry is configured to store interaction history comprising prior prompt sentences, response information, and user-selected edits, and to incorporate the interaction history into subsequently generated prompt sentence candidates to maintain contextual continuity across interaction sessions.

15. The system according to claim 14, wherein the circuitry is configured to retrieve, from the interaction history, a prior prompt-response pair associated with a matching technology type label, and to include the prior prompt-response pair as context in a subsequent prompt sentence generation operation.

16. The system according to claim 1, wherein the circuitry is configured to monitor a reconstruction error of an autoencoder model trained on normal-quality response information, and to initiate a re-query operation to the generative neural network model when the reconstruction error exceeds a predetermined anomaly threshold.

17. The system according to claim 1, wherein the circuitry is configured to receive scheduling information associating the identified organizations with scheduled events, generate updated prompt sentence candidates incorporating the scheduling information, and transmit the updated prompt sentence candidates to the terminal device.

18. A system comprising:
circuitry configured to:
access, via a communication interface coupled to a packet-switched network, a plurality of information providing devices and collect unstructured document information based on acquisition target identification information;
extract character information from the collected document information, apply language identification and machine translation processing to normalize the character information, and apply a natural language processing pipeline including a generative neural network model to extract organization information and case information from the normalized character information;
calculate an activity index for each identified organization based on occurrence frequency, recency weighting, and technology diversity score derived from the extracted case information, and identify organizations satisfying an activity threshold;
generate summary information associating attribute information comprising industry type, geographic region, technology type, and activity index for each identified organization, and store the summary information as structured information in a storage device;
execute a prompt sentence generation process that generates a plurality of question-type prompt sentence candidates based on the summary information and the structured information; and
transmit the prompt sentence candidates and summary information to a terminal device, receive a selected or edited prompt sentence, transmit the selected or edited prompt sentence to the generative neural network model, and return response information to the terminal device.

19. The system according to claim 18, wherein the circuitry is configured to store the selected or edited prompt sentence and the corresponding response information as a prompt-response pair in the storage device, and to retrieve stored prompt-response pairs for incorporation into subsequently generated prompt sentence candidates.

20. A method comprising:
accessing, via a communication interface coupled to a packet-switched network, a plurality of information providing devices and collecting unstructured document information from external sources based on acquisition target identification information;
extracting character information from the collected document information, performing language type determination and machine translation processing to normalize the character information, and executing a natural language processing algorithm including a generative neural network model to extract organization information and case information from the normalized character information;
calculating, based on the extracted organization information and the case information, an activity index for each identified organization and identifying organizations satisfying an activity threshold;
generating summary information associating attribute information comprising industry type, geographic region, technology type, and the activity index for each identified organization, and storing the summary information as structured information in a storage device;
executing a prompt sentence generation process that instructs the generative neural network model to generate a plurality of prompt sentence candidates based on the summary information and the structured information; and
transmitting the plurality of prompt sentence candidates and the summary information via the communication interface to a terminal device, receiving a selected or edited prompt sentence from the terminal device, transmitting the selected or edited prompt sentence to the generative neural network model, and returning response information from the generative neural network model to the terminal device.
